(19) United States
(12) Patent Application Publication
(10) Pub. No.: US 2026/0291193 A1
(43) Pub. Date: Sep. 24, 2026

(54) ELECTRICAL PEDESTAL

(71) Applicant: WCM Industries, Inc., Colorado Springs, CO (US)

(72) Inventors: William T. Ball, Colorado Springs, CO (US); Eric Pilarczyk, Colorado Springs, CO (US); Gabriel Young, Colorado Springs, CO (US)

(73) Assignee: WCM Industries, Inc., Colorado Springs, CO (US)

(21) Appl. No.: 19/692,264

(22) Filed: May 29, 2026

Related U.S. Application Data
(63) Continuation-in-part of application No. 18/934,678, filed on Nov. 1, 2024.
(60) Provisional application No. 64/058,998, filed on May 6, 2026.

(51) Int. Cl. H02G 3/04; H02G 3/34

(52) U.S. Cl. CPC H02G 3/0493; H02G 3/34

(57) ABSTRACT

An improved electrical pedestal for a roof is provided. The electrical pedestal may include an electrical support pole raceway (ESPR) to guide electrical wiring through a roof and to provide structural support for the electrical pedestal. The electrical pedestal may include an integrated wiring transition box (IWTB) to guide electrical wiring to different electrical components on the electrical pedestal. The electrical pedestal may include electrical pedestal stability support bracket (EPSSB) to adjustably secure the pedestal to a roof without a need for additional roof penetrations. The electrical pedestal may also include a support plate configured to support and attach to one or more electrical components.

### CROSS-REFERENCE TO RELATED APPLICATION

This application is a continuation-in-part of, and claims priority to, U.S. patent application Ser. No. 18/934,678, filed Nov. 1, 2024, and entitled “IMPROVED ELECTRICAL PEDESTAL,” and which application is hereby incorporated by reference in its entirety. This application also claims the benefit of U.S. Provisional Application No. 64/058,998, filed May 6, 2026, and entitled “IMPROVED ELECTRICAL PEDESTAL,” and which application is hereby incorporated by reference in its entirety.

### BACKGROUND

An electrical rooftop pedestal is a device used to mount electrical circuitry for controlling various types of electrical equipment on roofs (e.g., air conditioners, air handlers, motor starters, solar panels, lights, refrigeration, heat pumps). There is a need to install safety components, such as electrical disconnects, on electrical rooftop pedestals in an efficient manner.

It is with respect to this general technical environment that aspects of the present application are directed.

### SUMMARY

In an aspect, the present application relates to an electrical pedestal assembly for a roof, comprising: an electrical support pole raceway (ESPR), comprising a hollow shell having a top portion including a top opening and a bottom portion including a bottom opening; an integrated wiring transition box (IWTB) configured to be attached to the top portion of the ESPR, wherein the IWTB comprises an enclosure having an first aperture, a second aperture, and a third aperture, wherein the first aperture at least partially aligns with the top opening of the ESPR when the IWTB is attached to the ESPR; a support plate attached to the IWTB and configured to support one or more electrical components; an electrical pedestal stability support bracket (EPSSB) removably attached to the bottom portion of the ESPR.

In some examples, the electrical pedestal assembly further comprises: an electrical junction box attached to a bottom portion of the ESPR; and a collar attached to the bottom portion of the ESPR and proximal to the electrical junction box, wherein the collar is attached to the electrical junction box via a support bracket.

In some examples, the electrical pedestal assembly further comprises: a upper flange fixedly attached to the ESPR; wherein the EPSSB is slidingly adjustable along the ESPR to a height below the upper flange.

In some examples, the one or more electrical components comprise a ground fault circuit interrupter (GFCI) outlet, an electrical disconnect component, or both.

In some examples, the support plate comprises a plurality of apertures spaced to allow attachment of the one or more electrical components.

In some examples, the EPSSB is further configured to attach to a plurality of struts, and the plurality of struts extend substantially orthogonally to a longitudinal axis of the ESPR.

In some examples, the EPSSB comprises a main body, the main body having a first thickness; a bracket portion, extending from the main body and including at least one adjustment aperture, wherein the main body and the bracket portion define a through hole configured to receive the ESPR; a first flange, having a second thickness that is less than the first thickness and extending from the main body radially away from the through hole, the first flange including at least a first fastener aperture; and a second flange, having a third thickness that is less than the first thickness and extending from the main body radially away from the through hole of the main body, the second flange including at least a second fastener aperture.

In some examples, a cross section of the ESPR in a plane orthogonal to a longitudinal axis of the ESPR is substantially round or substantially oval.

In some examples, an outside surface of the ESPR is curved.

In some examples, the support plate comprises a through hole that at least partially aligns with the third aperture of the IWTB.

In some examples, the electrical pedestal assembly further comprises: a grounding bushing attached to the bottom portion of the ESPR, wherein the grounding bushing is configured to electrically connect the ESPR to a ground wire.

In some examples, the one or more electrical components comprise an electrical disconnect component and a ground fault circuit interrupter (GFCI) outlet, wherein the electrical disconnect component is attached to a first surface of the support plate, and wherein the GFCI outlet is attached to a second surface of the support plate that is opposite to and substantially parallel with the first surface of the support plate.

In some examples, the ESPR is configured to be threadingly attached to the IWTB.

In another aspect, the present application relates to a pedestal assembly for a roof, comprising: an electrical support pole raceway (ESPR) comprising a hollow, rigid shell; an upper flange attached to the ESPR; and an electrical pedestal stability support bracket (EPSSB) removably attached to the bottom portion of the ESPR and below the upper flange, wherein the EPSSB is further configured to attach to a plurality of struts for attachment of the EPSSB to an underside of a roof.

In some examples, the EPSSB comprises: a main body, the main body having a first thickness; a bracket portion, extending from the main body and including at least one adjustment aperture, wherein the main body and the bracket portion define a through hole configured to receive the ESPR; a first flange, having a second thickness that is less than the first thickness and extending from the main body radially away from the through hole, the first flange including at least a first fastener aperture; and a second flange, having a third thickness that is less than the first thickness and extending from the main body radially away from the through hole of the main body, the second flange including at least a second fastener aperture.

In some examples, a cross section of the ESPR in a plane orthogonal to a longitudinal axis of the ESPR is substantially round or substantially oval.

In some examples, an outside surface of the ESPR is curved.

In some examples, the pedestal assembly, wherein at least one of the upper flange or the EPSSB is slidingly adjustable along the ESPR.

In another aspect, the present application relates to an electrical pedestal assembly for a roof, comprising: a pedestal assembly, comprising, an electrical support pole raceway (ESPR) comprising a hollow, rigid shell; an upper flange fixedly attached to the ESPR; and an electrical pedestal stability support bracket (EPSSB) configured to be attached to a bottom portion of the ESPR and below the upper flange, wherein the EPSSB is slidingly adjustable along the ESPR; and a support plate assembly, comprising, an integrated wiring transition box (IWTB) configured to be removably attached to the top portion of the ESPR, wherein the IWTB comprises an enclosure having an first aperture, a second aperture, and a third aperture, wherein the first aperture at least partially aligns with the top opening of the ESPR when the IWTB is attached to the ESPR; a support plate, attached to the IWTB having a first surface and an opposite, second surface and including a through hole that at least partially aligns with the third aperture; a first electrical component attached to the first surface; and a second electrical component attached to the second surface.

In some examples, the EPSSB comprises: a main body, the main body having a first thickness; a bracket portion, extending from the main body and including at least one adjustment aperture, wherein the main body and the bracket portion define a through hole configured to receive the ESPR; a first flange, having a second thickness that is less than the first thickness and extending from the main body radially away from the through hole, the first flange including at least a first fastener aperture; and a second flange, having a third thickness that is less than the first thickness and extending from the main body radially away from the through hole of the main body, the second flange including at least a second fastener aperture.

In an aspect, the present application relates to an electrical pedestal assembly for a roof, comprising: an electrical support pole raceway (ESPR) comprising a hollow, rigid shell; a support plate having a first surface and an opposite, second surface; a first electrical component comprising an electrical disconnect component; and a second electrical component comprising an electrical disconnect component, wherein the first electrical component is mounted on the first surface of the support plate, and wherein the second electrical component is mounted on the second surface of the support plate.

In some examples, the electrical pedestal assembly further comprises a first conduit corresponding to the first electrical component and a second conduit corresponding to the second electrical component.

In some examples, the electrical pedestal assembly further comprises a first collar attached to the support plate and configured to clamp onto at least one of the first conduit or the second conduit.

In some examples, the electrical pedestal assembly includes a respective first collar for each of the first conduit and the second conduit.

In some examples, the electrical pedestal assembly further comprises a mounting block, wherein the support plate is mounted to the mounting block, and the mounting block is mounted to the ESPR.

In some examples, the mounting block is further configured to provide a wiring transition between the ESPR and both of the first electrical component and the second electrical component.

In some examples, the electrical pedestal assembly further comprises: an electrical junction box attached to a bottom portion of the ESPR; and a collar attached to the bottom portion of the ESPR and proximal to the electrical junction box, wherein the collar is attached to the electrical junction box via a support bracket.

In another aspect, the present application relates to an electrical pedestal assembly for a roof, comprising: an electrical support pole raceway (ESPR), comprising a hollow shell having a top portion including a top opening and a bottom portion including a bottom opening; a first electrical component comprising an electrical disconnect component; a threaded portion of the ESPR extending upward from the top portion of the ESPR and through an opening in a bottom wall of a housing of the first electrical component; and a pair of locking nuts engaged with the threaded portion, wherein the pair of locking nuts clamp the bottom wall therebetween, thereby mechanically securing the first electrical component to the ESPR.

In some examples, a first locking nut of the pair of locking nuts is configured to be disposed on an underside of the first electrical component and is configured to be advanced upward until the first locking nut bears against the underside of the bottom wall.

In some examples, a second locking nut of the pair of locking nuts is configured to be disposed inside the housing of the first electrical component and is configured to be advanced until the second locking nut bears against an inner surface of the bottom wall.

In some examples, the electrical pedestal assembly further comprises an electrical junction box attached to a bottom portion of the ESPR.

In some examples, the electrical pedestal assembly further comprises: an upper flange attached to the ESPR; and an electrical pedestal stability support bracket (EPSSB) removably attached to a bottom portion of the ESPR and below the upper flange, wherein the EPSSB is further configured to attach to a plurality of struts for attachment of the EPSSB to an underside of a roof.

In some examples, an outside surface of the ESPR is curved.

In another aspect, the present application relates to an electrical pedestal assembly for a roof, comprising: an electrical support pole raceway (ESPR) comprising a hollow, rigid shell; a first electrical component comprising an electrical disconnect component, wherein the ESPR is coupled directly to a housing of the first electrical component; an electrical junction box attached to a bottom portion of the ESPR; and an electrical pedestal stability support bracket (EPSSB) removably attached to the bottom portion of the ESPR, wherein the EPSSB is further configured to attach to a plurality of struts for attachment of the EPSSB to an underside of a roof.

In some examples, the electrical pedestal assembly further comprises an upper flange attached to the ESPR.

In some examples, the electrical pedestal assembly further comprises a collar attached to the bottom portion of the ESPR and proximal to the electrical junction box, wherein the collar is attached to the electrical junction box via a support bracket.

In some examples, the electrical pedestal assembly further comprises a threaded portion of the ESPR extending upward through an opening in a bottom wall of the housing of the first electrical component.

In some examples, the electrical pedestal assembly further comprises a pair of locking nuts engaged with the threaded portion.

In some examples, the pair of locking nuts clamps the bottom wall therebetween, thereby mechanically securing the first electrical component to the ESPR.

In some examples, the electrical pedestal assembly further comprises a grounding bushing attached to the bottom portion of the ESPR, wherein the grounding bushing is configured to electrically connect the ESPR to a ground wire.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

There are shown in the drawings examples that are presently preferred, it being understood, however, that the invention is not limited to the precise arrangements and configurations shown.

FIG. 1 illustrates a perspective view of an example electrical pedestal assembly.

FIG. 2 illustrates a perspective view of a portion of an example electrical pedestal assembly and a portion of a roof.

FIG. 3 illustrates a front view of an example electrical pedestal assembly.

FIG. 4 illustrates a side view of an example electrical pedestal assembly.

FIG. 5 illustrates a rear view of an example electrical pedestal assembly.

FIG. 6 illustrates a perspective view of an example electrical pedestal stability support bracket (EPSSB).

FIG. 7 illustrates another perspective view of an example EPSSB.

FIG. 8 illustrates another perspective view of an example electrical pedestal assembly, including an example pedestal assembly and an example support plate assembly.

FIG. 9 illustrates a rear view of an example pedestal assembly.

FIG. 10 illustrates a front view of an example support plate assembly.

FIG. 11 illustrates another front view of an example support plate assembly.

FIG. 12 illustrates a rear view of an example support plate assembly.

FIG. 13 illustrates another front view of an example support plate assembly.

FIG. 14 illustrates a perspective view of an example support plate assembly.

FIG. 15 illustrates a top view of an example support plate assembly.

FIG. 16 illustrates a front view of an example support plate assembly.

FIG. 17 illustrates an perspective view of an example support plate assembly with a shroud.

FIG. 18 illustrates a front view of an example support plate assembly.

FIG. 19 illustrates a cross-sectional perspective view of an example support plate assembly.

FIG. 20 illustrates a cross-sectional side view of an example support plate assembly.

FIG. 21A illustrates a front view of an electrical junction box and a bottom portion of an ESPR.

FIG. 21B illustrates a side view of an electrical junction box and a bottom portion of an ESPR.

FIG. 22 illustrates a perspective view of an example electrical pedestal assembly with a spaced EPSSB.

FIG. 23 illustrates a perspective view of an example roof of an example electrical pedestal assembly with a spaced EPSSB.

FIG. 24 illustrates a front view of an example roof of an example electrical pedestal assembly with a spaced EPSSB.

FIG. 25 illustrates a side view of an example electrical pedestal assembly with a spaced EPSSB.

FIG. 26 illustrates a perspective view of an example electrical pedestal assembly having two electrical disconnect components mounted on opposite sides of a support plate.

FIG. 27 illustrates a side view of the example electrical pedestal assembly of FIG. 26.

FIG. 28 illustrates a cross-sectional side view of an upper portion of the example electrical pedestal assembly of FIG. 26, showing the support plate and the two electrical disconnect components and their associated wiring transition structures.

FIG. 29 illustrates a front view of an example support plate assembly for a dual-disconnect configuration, showing a lower cutout of the support plate, a double-sided mounting block received in the lower cutout, tabs of the support plate attached to the double-sided mounting block, and an ESPR received in the double-sided mounting block.

FIG. 30A illustrates a top perspective view of the example assembly of FIG. 29, including the support plate, the double-sided mounting block, the ESPR, and electrical components mounted on opposite sides of the support plate.

FIG. 30B illustrates a bottom perspective view of the example assembly of FIG. 29.

FIG. 31A illustrates a top perspective view of the double-sided mounting block of FIG. 29, showing threaded apertures at an upper portion of the double-sided mounting block.

FIG. 31B illustrates a bottom perspective view of the double-sided mounting block of FIG. 29, showing a threaded aperture configured to receive the ESPR.

FIG. 32 illustrates a partially exploded perspective view of an example electrical pedestal assembly in which an electrical disconnect component is attached directly to an electrical support pole raceway.

FIG. 33 illustrates a perspective view of the example electrical pedestal assembly of FIG. 32 in an assembled state.

FIG. 34 illustrates an enlarged perspective view of an upper portion of the example electrical pedestal assembly of FIG. 32 showing a direct attachment interface between the electrical support pole raceway and the electrical disconnect component and wiring routed from the raceway toward the electrical disconnect component.

### DETAILED DESCRIPTION

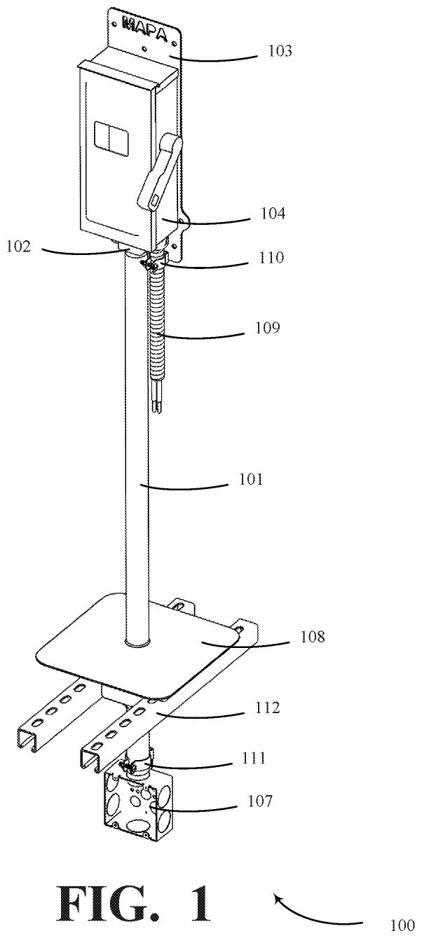

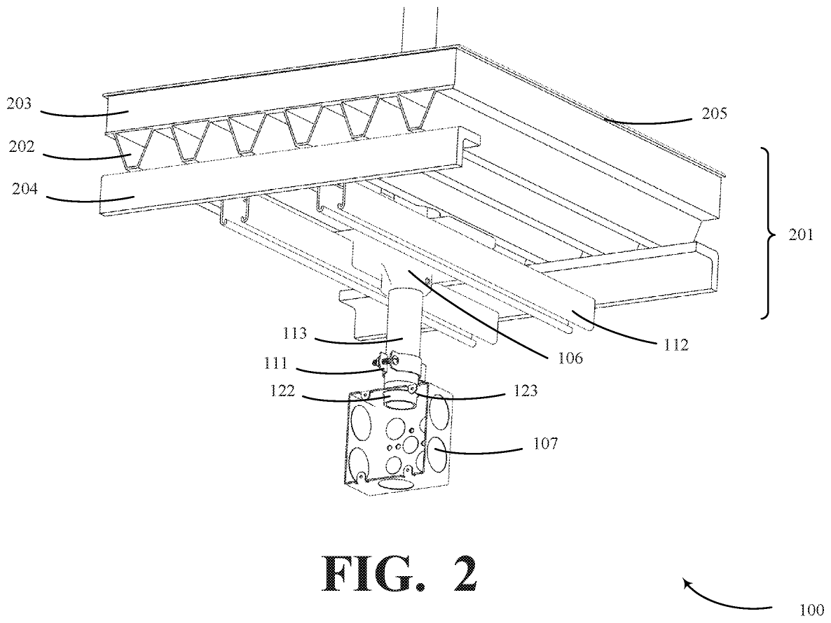

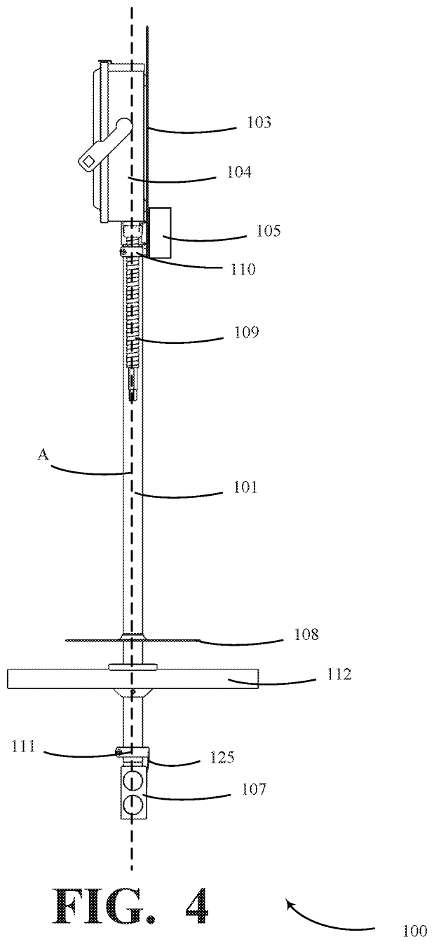

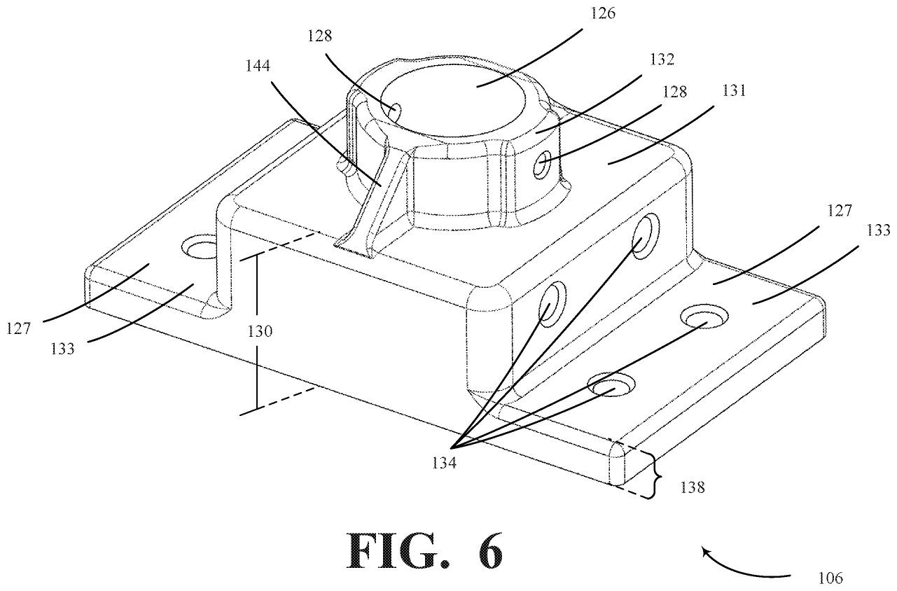

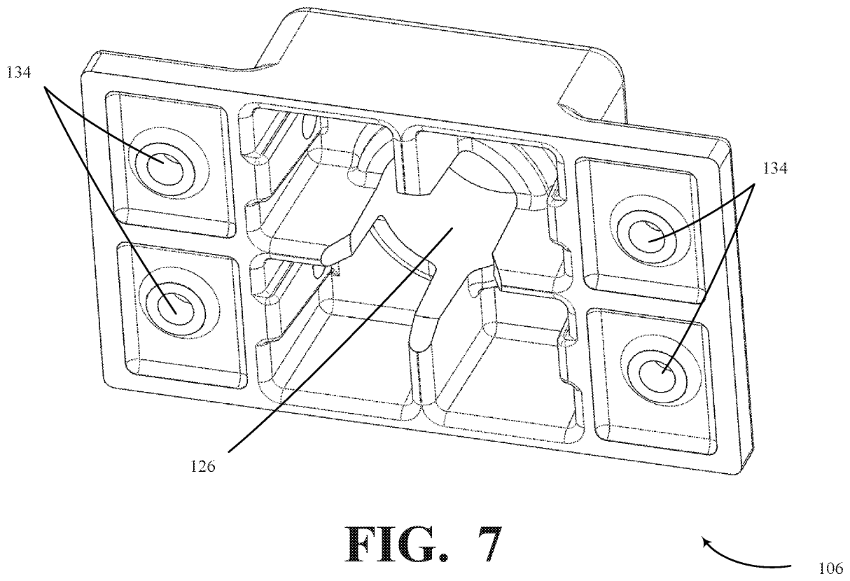

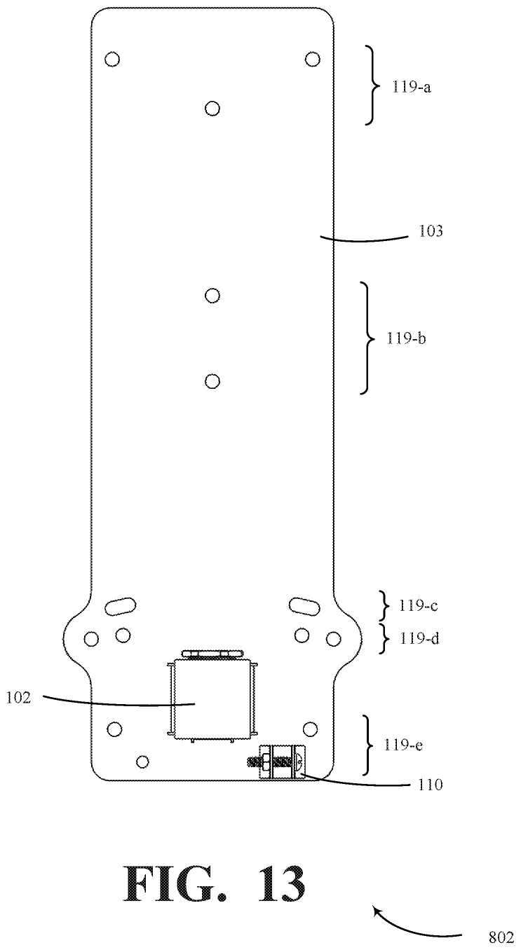

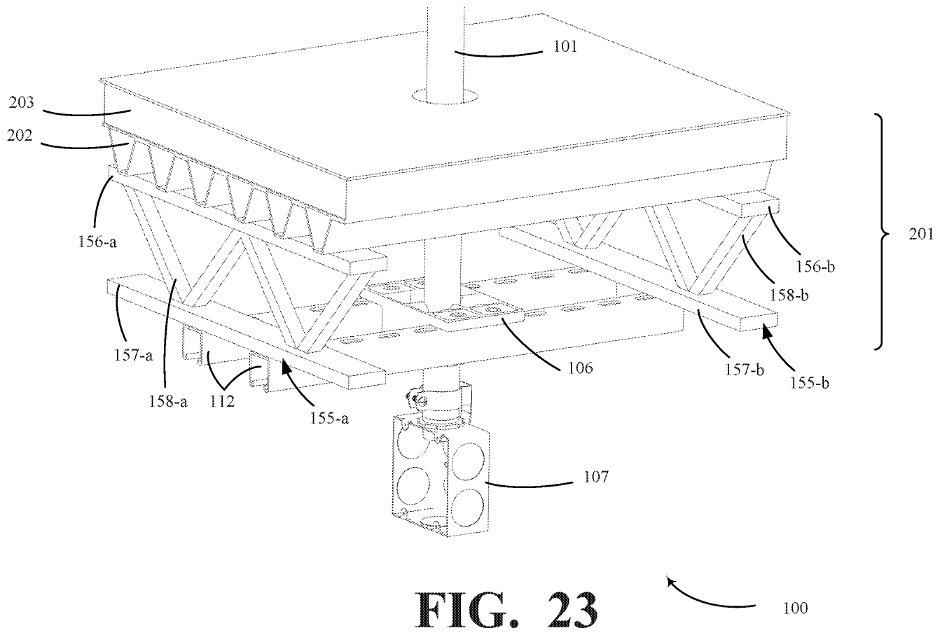

Referring concurrently to FIGS. 1-25, electrical pedestal assembly 100 includes, e.g., an electrical support pole raceway (ESPR) 101, an integrated wiring transition box (IWTB) 102, a support plate 103, first electrical component 104 (e.g., an electrical disconnect component), second electrical component 105 (e.g., a ground fault circuit interrupter (GFCI) outlet) (FIG. 4), an electrical pedestal stability support bracket (EPSSB) 106 (FIG. 2), an electrical junction box 107, an upper flange 108, a conduit 109, a first collar 110, a second collar 111, or any combination of these.

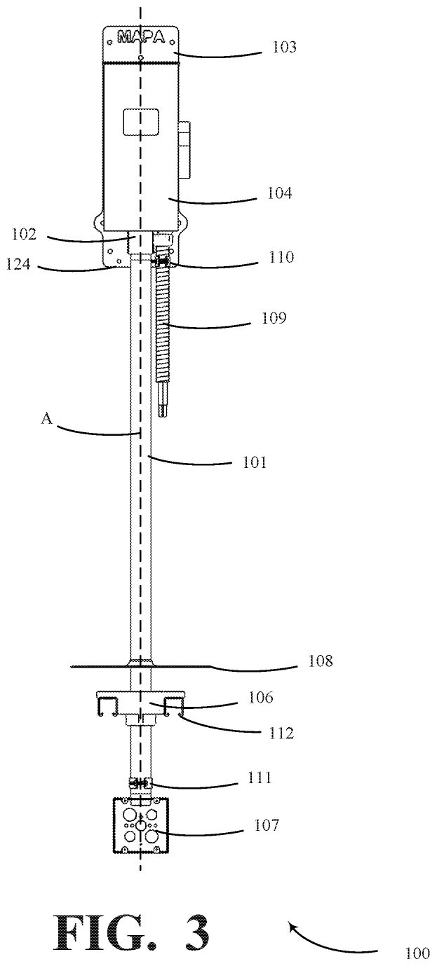

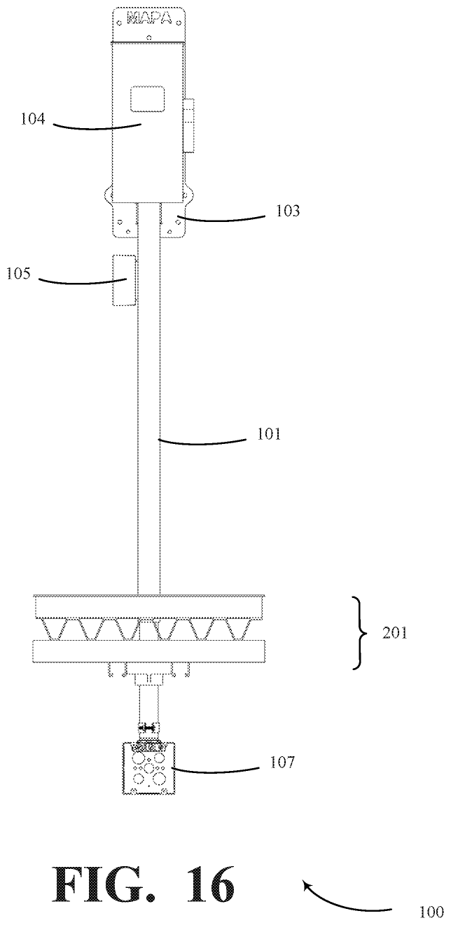

ESPR 101 is a rigid support pole raceway for electrical wiring. As shown, for example, in FIG. 2, ESPR 101 extends from below a roof 201 (e.g., a commercial or flat roof) to above the roof 201 when installed. ESPR 101 may comprise a rigid, hollow cylinder (such as a tube) to guide electrical wiring through ESPR 101. For example, ESPR may include a top opening and a bottom opening and a passageway therebetween. ESPR 101 may also define a longitudinal axis A along its length (FIG. 3). In examples, both of the inner cross-section of the ESPR 101 and the outer cross-section of the ESPR 101 (e.g., in a plane orthogonal to longitudinal axis A of ESPR 101) are round; however, other cross-sectional shapes for one or both are possible, such as an oval, a rectangle, a square (FIG. 16), etc. In examples,, support plate 103 and/or second electrical component 105 may be directly attached to ESPR 101, and certain features of IWTB 102 (e.g., apertures) may be integral to ESPR 101. For example, when ESPR 101 has a square or rectangular cross-sectional shape, or includes at least one substantially flat surface, there may or may not be a separate IWTB 102 part distinct from the ESPR 101, and ESPR 101 may perform certain functions of the IWTB 102. ESPR 101 may provide weatherproofing or waterproofing for wiring disposed in ESPR 101. In examples, ESPR 101 may comprise a rigid tubular hollow shell. In some examples, such as when the ESPR comprises a tubular hollow shell, an outer surface 113 of ESPR 101 may be curved. In some examples, an inside or outside diameter of ESPR 101 may be approximately one and one quarter inches. In some examples, ESPR 101 may be able to be sized differently depending on the gauge wire(s) needed for first electrical component 104 and/or second electrical component 105. For example, an inside or outside diameter of ESPR 101 may be, or be greater than or less than, approximately one and one quarter inches.

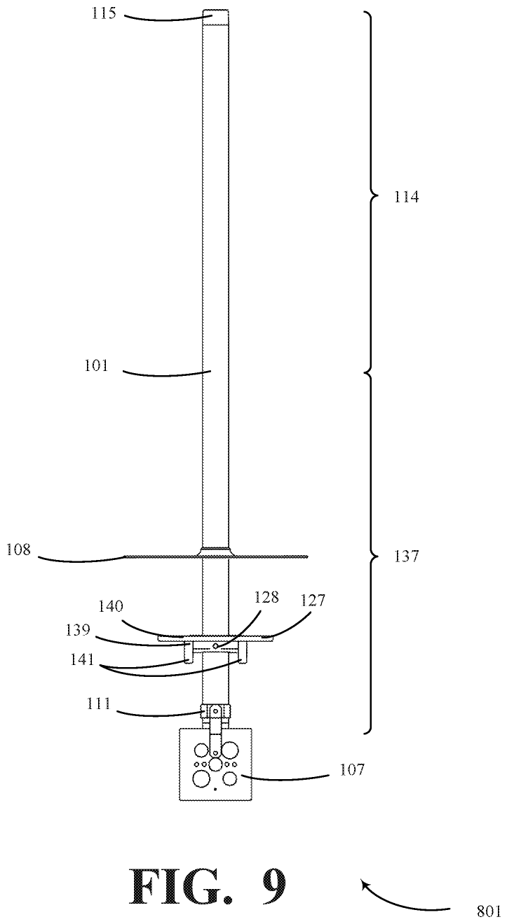

In examples, ESPR 101 comprising a hollow cylinder facilitates easier installation of electrical pedestal assembly 100. For example, it may be easier to drill or otherwise create a circular hole in roof 201 than a square or rectangular hole. Additionally, it may be easier to slide a sealing boot over ESPR 101 and/or otherwise seal a boot to the curved outer surface 113 of ESPR 101 than traditionally square or rectangular pedestals. ESPR 101 may carry wires rated for different voltages (e.g., 120 V, 240 V, and/or 480 V). In examples, ESPR 101 enables a single roof penetration to enable wires connected to multiple voltage sources through a raceway while simultaneously providing structural stability to electrical pedestal assembly 100. For example, ESPR 101 may be made of rigid (e.g., inflexible) material so that, in conjunction with EPSSB 106 and support plate 103, ESPR 101 serves as both an electrical raceway and a support pole for support plate 103 and any attached components. In addition, at a top portion 114 (FIG. 9) of ESPR 101, IWTB 102 may be attached to ESPR 101 and may be configured to separate wires that are guided through ESPR 101, such as wires connected to different voltage sources. In some examples, the ESPR 101 may be adapted to meet all applicable requirements for acting as both a support for the first electrical component and/or second electrical component and as a raceway. For example, an internal cylindrical surface within ESPR 101 may be coated with an insulated material. Additionally or alternatively, ESPR 101 may include, within the hollow tube, a sleeve made at least partially of an insulated material (e.g., plastic).

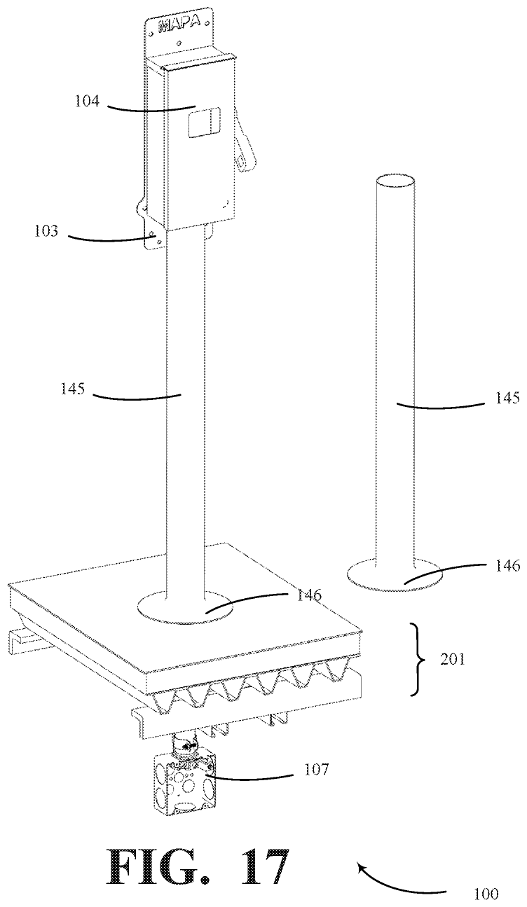

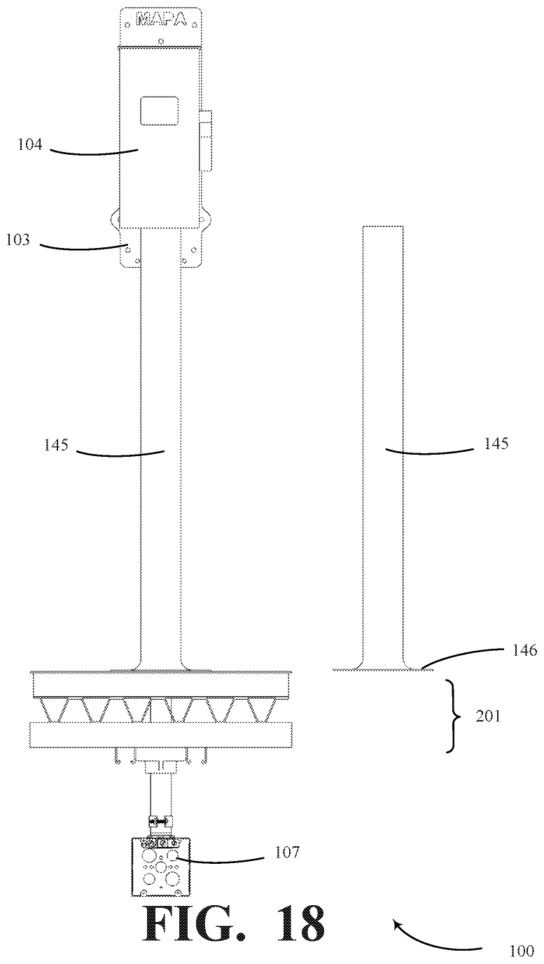

Referring to FIGS. 17 and 18, ESPR 101 may, in some examples, be at least partially covered by a shroud 145. Shroud 145 may include a substantially cylindrical pipe or hollow tube with a substantially same or similar length as ESPR 101. Shroud 145 may envelop or cover ESPR 101 to shield ESPR 101 from water or other aspects of the environment. In some examples, shroud 145 may include a base 146 that extends radially outwards from an end of shroud 145 and may be configured to at least partially or entirely cover upper flange 108. For example, base 146 of shroud 145 may be disposed above roof 201. In some examples, shroud 145 may include an aperture (not shown) along the length of shroud 145 which may provide an opening for second electrical component 105 to be accessible, as shown in FIG. 16. At least a portion of shroud 145 may be made of a rubber material or a metal material. In some examples, shroud 145 may be used in addition to ESPR 101 so that connections between ESPR 101 and IWTB 102 or between the ESPR 101 and upper flange 108 need not, themselves, be watertight. Shroud 145 may be of different lengths, shapes, cross-sectional profiles, and/or materials depending on the particular installation. For example, shroud 145 may be shorter or longer than ESPR 101, and may have a circular, oval, or other cross-sectional shape. In some examples, shroud 145 may be omitted entirely, for example, when the connections between ESPR 101 and IWTB 102 or between ESPR 101 and upper flange 108 are otherwise sealed or waterproofed. In some examples, the shroud 145 may be provided by an installer and may comprise a material that matches the material of a roof membrane or other roofing components.

Roof 201 may include multiple layers or features. For example, roof 201 includes angle irons/trusses 204, corrugated roof 202, roof insulation 203, and/or membrane 205, although other roof constructions are possible and contemplated. Angle irons/trusses 204 may comprise structural elements that form the framework of roof 201. Corrugated roof 202 may comprise a covering for roof 201 (e.g., typically made of metal) that protects the underlying building. In this example, corrugated roof 202 is disposed above angle irons/trusses 204 and EPSSB 106. In examples, angle irons/trusses 204 may be considered an underside of roof 201. Roof insulation 203 may comprise material placed between corrugated roof 202 and membrane 205. Membrane 205 may comprise a waterproof barrier to prevent moisture from entering roof 201 and may protect roof insulation 203. ESPR 101 may extend through membrane 205, roof insulation 203, and corrugated roof 202 via a hole that is drilled (or otherwise created) through such layers. For example, an installer may drill a hole through the layers of roof 201 in the desired position between two angle irons/trusses 204 on the roof for the electrical wiring for electrical components 104, 105. As further discussed herein, the ESPR 101 may be secured to roof 201 using the EPSSB 106, upper flange 108, and struts 112 so as to not require buttressing physical support of electrical components 104 and/or 105 above the roof 201 or penetrations in roof 201 (other than the hole in roof 201 for ESPR 101). ESPR 101 may extend below struts 112 and angle irons/trusses 204, as illustrated. In addition, although corrugated roof 202 is pictured, other example roof materials may be substituted in any embodiments discussed herein, such as sheets of metal, wood, tile, polymer, concrete, or other suitable materials.

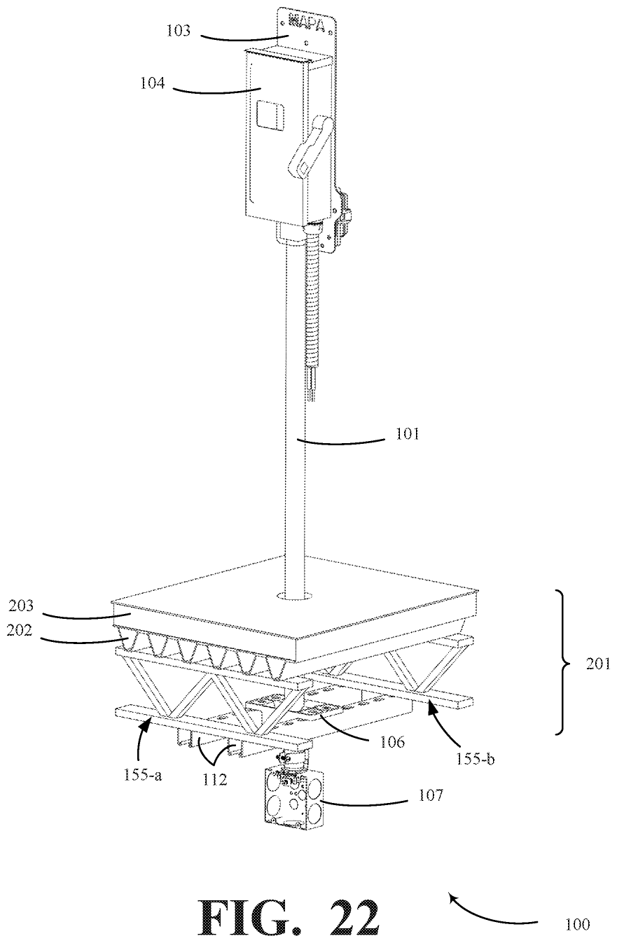

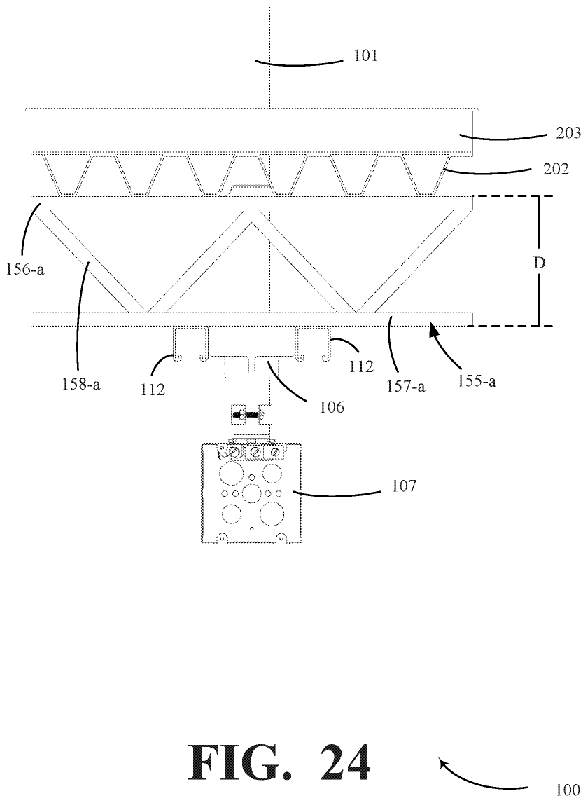

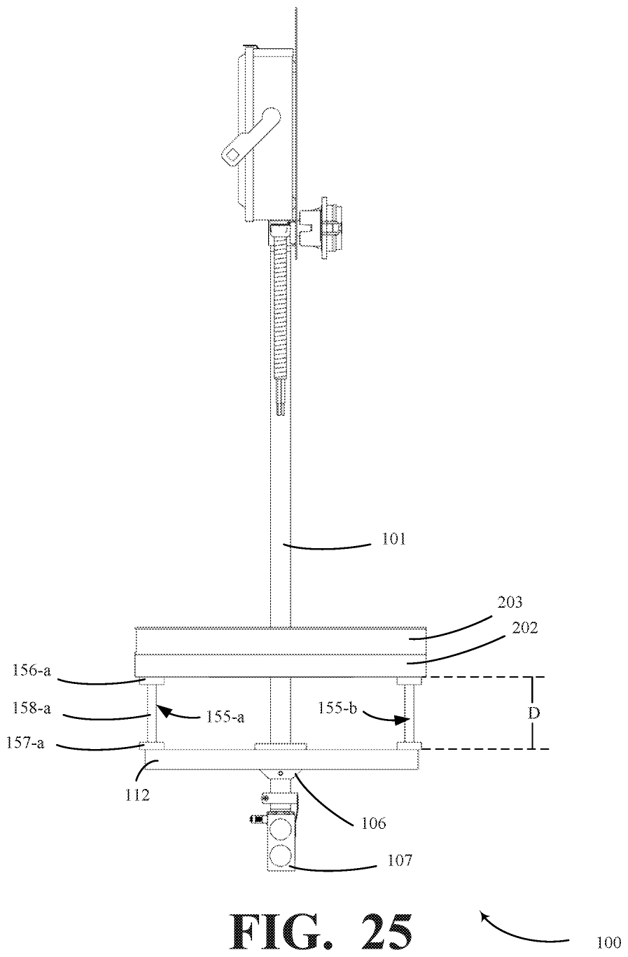

In some examples, as illustrated in FIGS. 22-25, roof 201 may include one or more girders 155 supporting corrugated roof 202/roof insulation 203 and EPSSB 106/struts 112. In such examples, girders 155 may be considered an underside of roof 201. For example, girders 155-a and 155-b (collectively, 155) may be substantially adjacent to, supporting, and/or attached to corrugated roof 202. Attaching struts 112 to girders 155 rather than to angle iron/trusses 204 may provide additional distance D (FIGS. 24-25) between EPSSB 106 and corrugated roof 202 and/or roof insulation 203, such that EPSSB 106 is not directly underneath corrugated roof 202 and/or roof insulation 203. Struts 112 may be attached to girders 155 in a manner similar to the described manner of attachment of struts 112 to angle irons/trusses 204. In some examples, distance D may be greater than one, two, three, or four times the thickness 130 of EPSSB 106 or any other distance below corrugated roof 202 and/or roof insulation 203. Girders 155 may include top chords 156-a and 156-b (collectively, 156), bottom chords 157-a and 157-b (collectively, 157), and web members 158-a and 158-b (collectively, 158). Top chords 156 and bottom chords 157 may be oriented substantially horizontally or substantially parallel to corrugated roof 202 and/or may be substantially orthogonal to ESPR 101 and/or struts 112, although other configurations are possible and contemplated.

In the illustrated example, top chords 156 may be disposed above bottom chords 157, and web members 158 may be disposed between top chords 156 and bottom chords 157. In some examples, struts 112 may be in contact with and attached to bottom surfaces of bottom chords 157. In some other examples, struts 112 may be in contact with and attached to top surfaces of bottom chords 157, bottom surfaces of top chords 156, or top surfaces of top chords 156 or any other surface of the girders 155, all of which may be considered an underside of roof 201. As EPSSB 106 may still be attached to struts 112, the distance D between EPSSB 106 and corrugated roof 202 and/or roof insulation 203 may be able to be varied based on particular roof configurations. In some examples, other structural members (e.g., beams, trusses, joists) may be used as alternatives to girders 155. For example, I-beams, or any other beams, may be used and may be oriented in a similar manner as girders 155, for example, substantially perpendicular to struts 112. In such examples, struts 112 may similarly be in contact with and attached to any portion of the alternative structural members, such as bottom surfaces of bottom flanges of I-beams, top surfaces of bottom flanges of the I-beams, bottom surfaces of top flanges of the I-beams, or top surfaces of top flanges of the I-beams, etc.

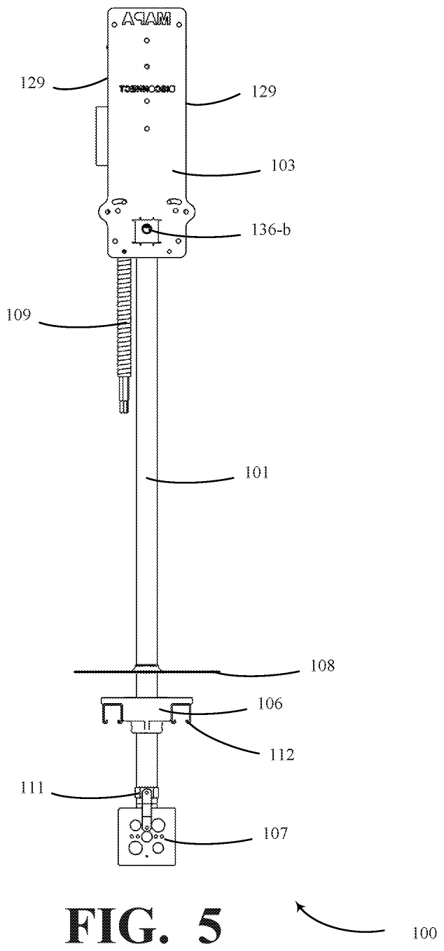

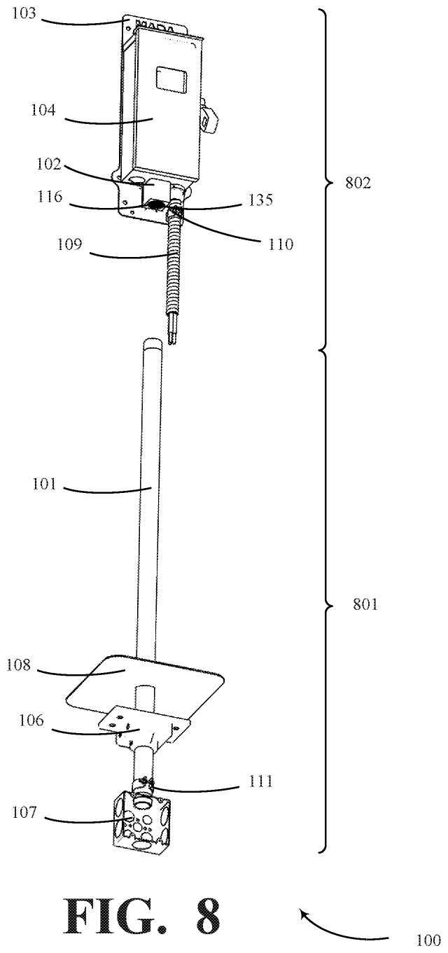

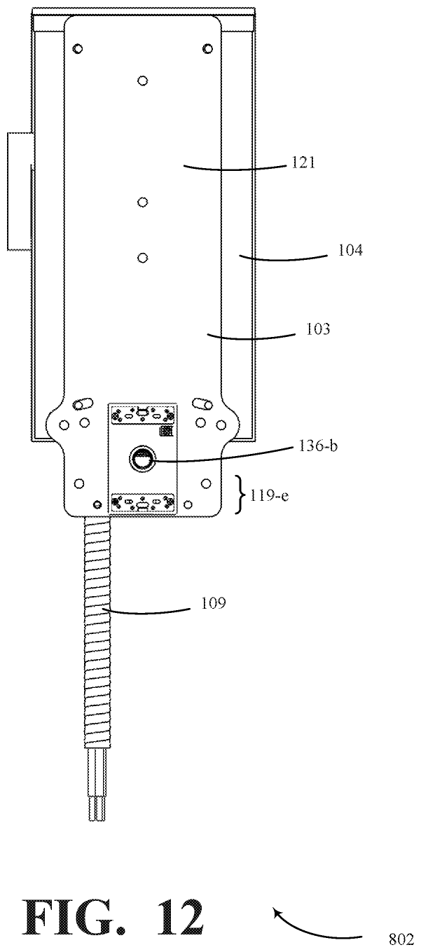

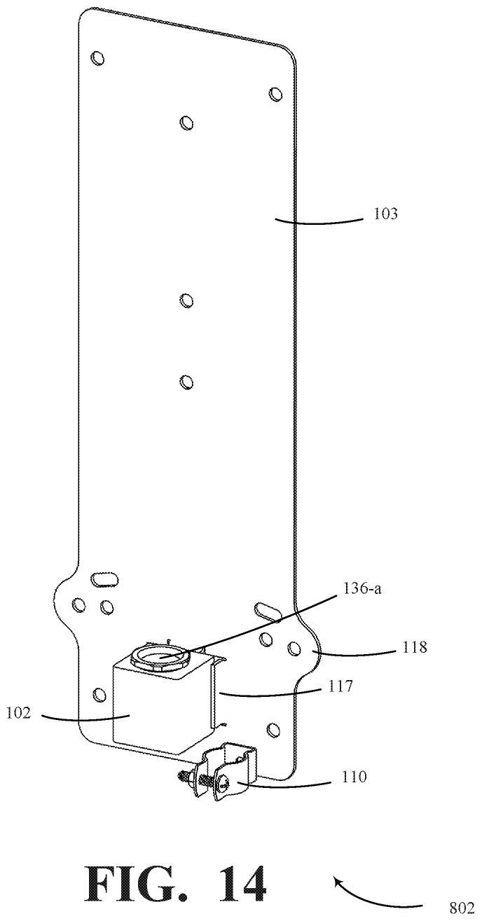

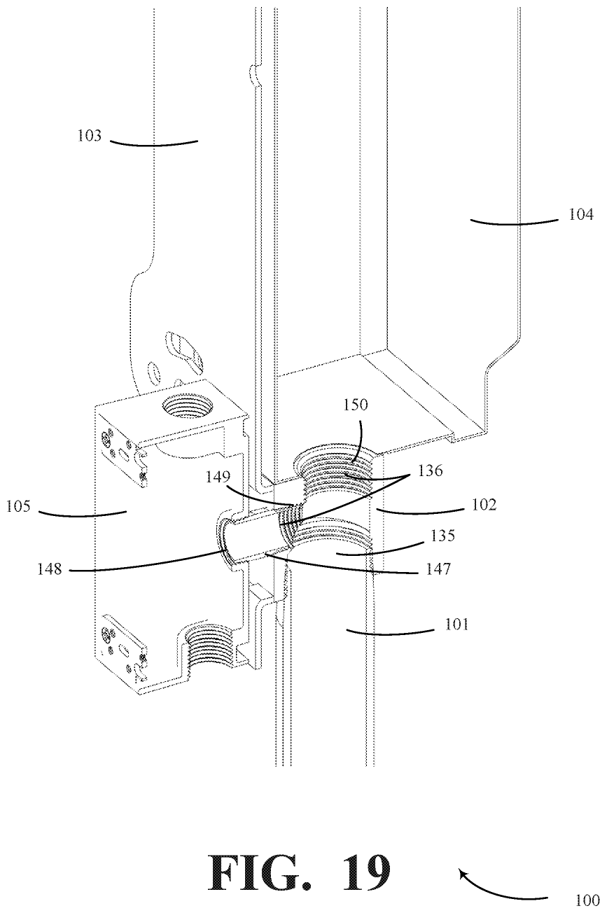

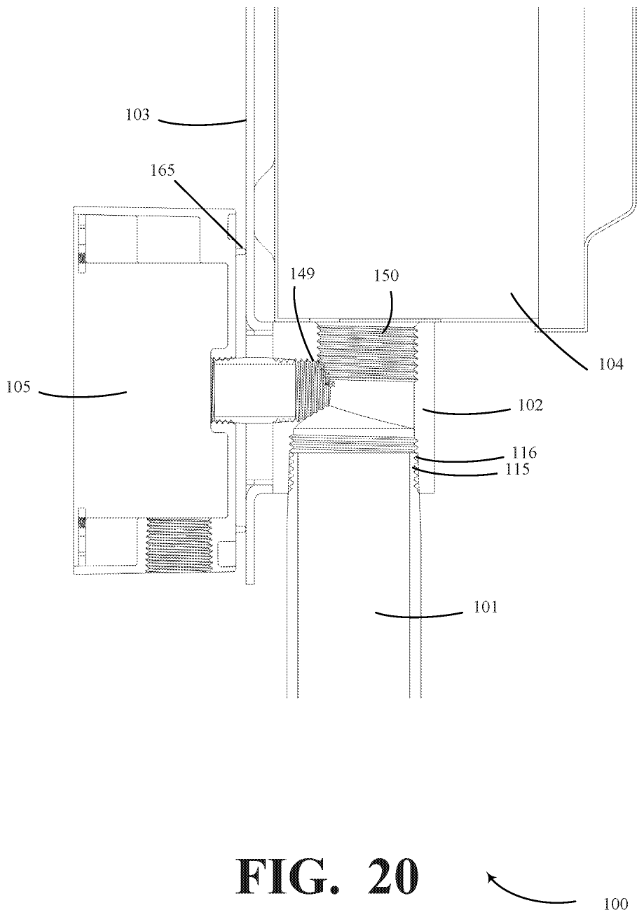

IWTB 102 is an enclosure configured to house electrical connections (e.g., wires, wire nuts, connectors, etc.) and may be attached to ESPR 101 at a top portion 114 (FIG. 9) of ESPR 101. As used herein, wires comprise both single conductors and multiple conductors (e.g., cables). IWTB 102 may be configured to receive wires from electrical components attached to support plate 103 (e.g., the first electrical component 104 and the second electrical component 105) and to provide passageway(s) for such wires to the ESPR 101. For example, IWTB 102 may include first aperture 135 (FIG. 8, 19-20) for wires from ESPR 101 and a plurality of (e.g., two) apertures 136 (FIG. 5, FIG. 14, and FIGS. 19-20) for wires connecting to the first electrical component 104 and the second electrical component 105. For example, first aperture 135 at least partially aligns with the top opening of ESPR 101 when IWTB 102 is attached to ESPR 101. In examples, the wires traversing the first aperture 135 and through second and third apertures 136 to the different electrical components 104, 105 may be of different gauges to accommodate different voltage sources. For example, wiring connected (e.g., via junction box 107) to different voltage sources of a building's main service panel(s) may be run through ESPR 101 into IWTB 102. Wiring provided through second aperture 136-a (FIG. 14) may be provided to the first electrical component 104, and wiring provided through third aperture 136-b (FIGS. 5, 12) may be provided to the second electrical component 105. In some examples IWTB 102 may be attached to ESPR 101 via threading (e.g., as shown in FIGS. 19 and 20), welding, or bonding. For example, ESPR 101 may include top outside threading 115 configured to couple with inside threading 116 of IWTB 102. IWTB 102 may additionally include threading 149 and/or threading 150 configured to couple with threaded chase nipple 147 and first electrical component 104, respectively. In other examples, ESPR 101 may be configured to attach to IWTB 102 in any number of other ways including adhesive-based attachment, welding, fasteners (e.g., screws), snap-in mechanisms, or any other attachment mechanism.

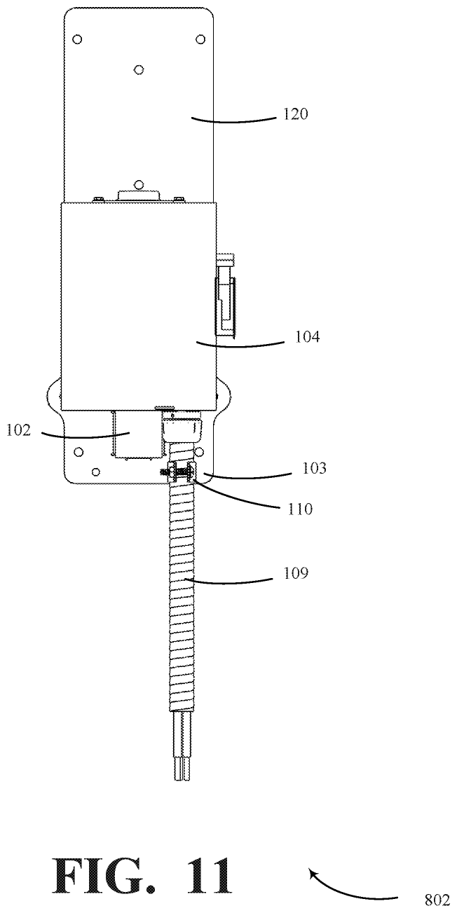

Support plate 103 is a substantially flat plate that serves as a mounting surface(s) for components (e.g., first electrical component 104, second electrical component 105, IWTB 102). Support plate 103 may be made out of substantially any material(s) including metals, plastics, and/or ceramics, among other rigid materials. In use, support plate 103 may be oriented vertically, that is, the length or longest dimension of support plate 103 may be oriented vertically. Support plate 103 may include a plurality of apertures 119 that may be used to secure first electrical component 104, second electrical component 105, and/or IWTB 102 to support plate 103 (e.g., using one or more fasteners such as screws, snap-in tabs, etc.). For example, apertures 119-a (e.g., three apertures) may be disposed in a triangle formation at a top portion of support plate 103. The top two apertures 119 of apertures 119-a may be disposed more proximally to side edges 129 (FIG. 5) of support plate 103 than the bottom aperture 119 of apertures 119-a. Apertures 119-b (e.g., two apertures) may be disposed in a vertical line formation at a center portion of support plate 103. Apertures 119-c (e.g., two apertures) may be slots (e.g., elongated apertures) disposed proximal to side edges 129 of support plate 103 and disposed at a bottom portion of support plate 103. Apertures 119-c may be angled with respect to side edges 129 (e.g., an acute angle). Apertures 119-d (e.g., four apertures) may be disposed in an arced or substantially horizontal line formation at the bottom portion of support plate 103. At least two apertures of apertures 119-d (e.g., the outside-most apertures 119-d) may be at least partially disposed on protrusions 118 of support plate 103. Apertures 119-d may be disposed below apertures 119-c. Apertures 119-e may be disposed in a trapezoidal formation or in two diagonal line formations at the bottom portion of support plate 103. Apertures 119-e may be disposed below apertures 119-d. The top two apertures 119 of apertures 119-e may be disposed more proximally to side edges 129 of support plate 103 than the bottom two apertures 119 of apertures 119-e. Apertures 119 may extend through support plate 103 (e.g., from surface 120 (FIG. 11) to surface 121 (FIG. 12) of support plate 103). Apertures 119 may be spaced from one another to allow attachment of first electrical component 104 and/or second electrical component 105.

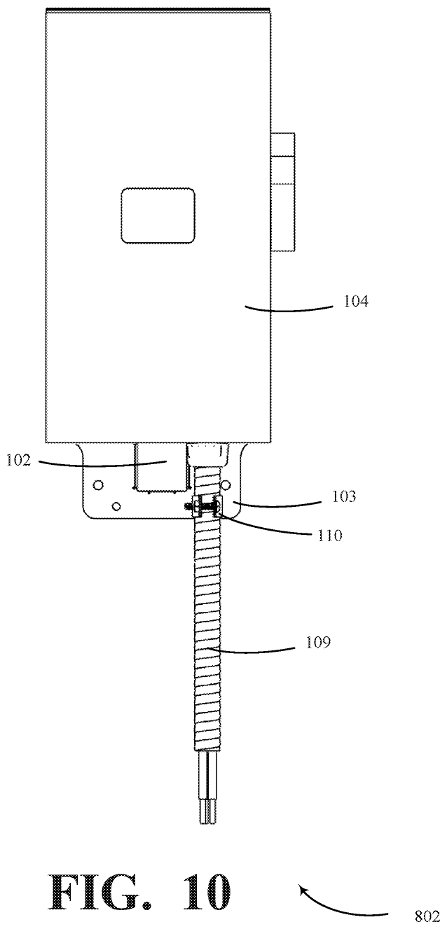

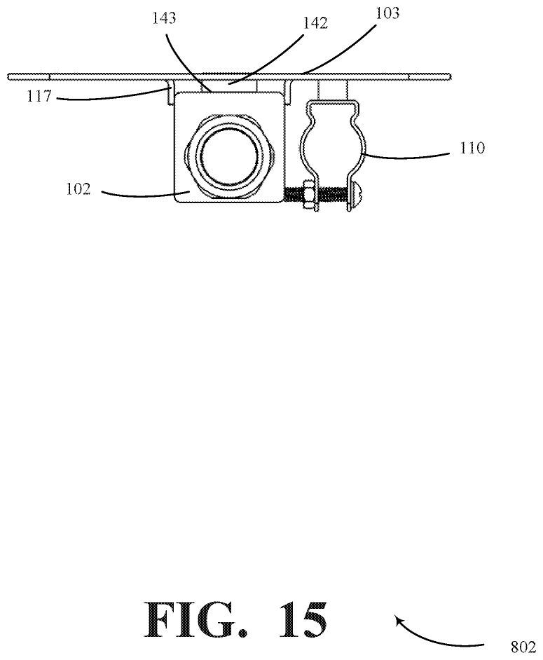

Support plate 103 may include one or more flanges 117 (FIGS. 14, 15), which may comprise tabs configured to secure IWTB 102 to support plate 103 (e.g., IWTB 102 may be welded to at least one or more of flanges 117). Flanges 117 may be disposed on surface 120 of IWTB 102 and at least a portion thereof may extend substantially orthogonally to surface 120 of support plate 103. In some examples, flange 142 may be attached to support plate 103 and/or IWTB 102 (e.g., via welding, bending, etc.). The distance that flange 142 protrudes outwards from (e.g., substantially orthogonal to) surface 120 of support plate 103 may be less than the distance that each of flanges 117 protrude outwards from (e.g., substantially orthogonal to) surface 120. For example, flanges 117 may extend past surface 143 of IWTB 102 that is proximal to surface 120 of support plate 103 and may be welded or otherwise attached to IWTB 102 as illustrated, while flange 142 extends to surface 143 of IWTB 102 and may be welded or otherwise attached to IWTB 102. Support plate 103 may include protrusions 118 (FIG. 14). Protrusions 118 may add additional width to certain portions of support plate 103 to allow for respective apertures to be disposed at least partially on protrusions 118. Some components (e.g., first electrical component 104, second electrical component 105) that may be mounted to support plate 103 may have widths greater than a width of support plate 103 (e.g., see FIG. 10). Protrusions 118 add additional width to be able to accommodate securing such components to support plate 103. In some examples, support plate 103 may be able to be sized differently depending on a size of first electrical component 104 and/or second electrical component 105. For example, FIGS. 10 and 11 illustrate differently sized first electrical components 104 attached to support plate 103. Protrusions 118 may be disposed at the bottom portion of support plate 103. In examples, the top portion of support plate 103 refers to the top third or top half of support plate 103, the center portion of support plate 103 refers to the middle third of support plate 103, and the bottom portion of support plate 103 refers to the bottom third or bottom half of support plate 103.

In examples, first electrical component 104 may comprise substantially any electrical component configured to generate, use, control, redirect, amplify or deamplify, store, sense, terminate, and/or interrupt electrical energy, among other functionality. In some examples, first electrical component 104 is an electrical disconnect component (including a housing therefor). An electrical disconnect component is a switch that separates electrical equipment from its power source. The electrical disconnect ensures that a particular electrical circuit (e.g., electrical equipment located on top of roof 201) is de-energized in the case of an emergency stoppage, service, or maintenance. An electrical disconnect, also known as a safety switch or isolator, is a device used to isolate a specific circuit or equipment from its power source. The core of a disconnect is a contact mechanism that can be manually operated. The contact mechanism may consist of two or more conductive contacts that can be separated or connected. A handle or lever may be attached to the contact mechanism. When the handle is moved to the “off” position, the contacts are separated, interrupting the flow of electricity. The mechanism may be housed within an enclosure, for example, made of a non-conductive material like plastic or fiberglass for safety and insulation. A grounding terminal of an electrical disconnect may ensure that the equipment is grounded, providing a safe path for electrical current to flow in case of a fault. In examples, electrical disconnect is grounded by connection to a grounding point on the support plate 103, which is, in turn, grounded via its connection to IWTB 102, which is grounded by connection to ESPR 101, which is grounded by connection to the electrical junction box 107 and/or grounding bushing 151, which is grounded typically through connection to the building's main service panel(s).

In some examples, first electrical component 104 may be secured to support plate 103 via one or more fasteners securing to at least a portion of apertures 119 of support plate 103. First electrical component 104 may be secured to surface 120 or surface 121. First electrical component 104 may be electrically connected to one or more components below roof 201 via wires extending from first electrical component 104, through IWTB 102, through ESPR 101, and through electrical junction box 107. First electrical component 104 may be electrically connected to one or more components (e.g., an air conditioner, air handler, etc.) on top of roof 201 (e.g., via conduit 109, or any other means). In some examples, first electrical component 104 may be attached to IWTB 102 via a threaded chase nipple or short threaded pipe configured to attach to threads of second aperture 136-a of IWTB 102 and to threads of first electrical component 104. In some examples, silicone may be added on the threads of the threaded chase nipple or short threaded pipe, second aperture 136-a, and/or first electrical component 104 to improve the seal. Welding or bonding may be used as an alternative coupling mechanism between first electrical component 104 and IWTB 102.

Second electrical component 105 represents substantially any electrical component configured to generate, use, control, redirect, amplify or deamplify, store, sense, terminate, and/or interrupt electrical energy, among other functionality. In some examples, second electrical component 105 is a ground fault circuit interrupter (GFCI) outlet. For example, the second electrical component 105 may comprise a GFCI housing (e.g., GFCI box) into which a GFCI circuit breaker is mounted. A GFCI is a circuit breaker designed to shut off electrical power to a particular electrical circuit (e.g., electrical equipment located on top of roof 201) in the event of a ground-fault event. A GFCI continuously monitors the balance of current flowing into and out of a circuit or equipment. Normally, the amount of current going in should approximately equal the amount coming out of the circuit or equipment. A difference in current may indicate a “ground fault,” where electricity is leaking to ground through an unintended path, for example, a person's body. GFCIs may include a transformer to sense the current flowing through both the “hot” and “neutral” wires of a circuit. The transformer compares the currents in these wires. If there is a difference (e.g., of even a few milliamps), it may indicate a ground fault. When a ground fault is detected, the GFCI interrupts the power supply to the circuit or equipment. In examples, the second electrical component 105 comprises an electrical outlet that includes a GFCI. In examples, the second electrical component is grounded by connection to a grounding point on support plate 103, as described.

In some examples, second electrical component 105 may be secured to support plate 103 via one or more fasteners securing to at least a portion of apertures 119 of support plate 103. Second electrical component 105 may be secured to surface 120 or surface 121. In some examples, first electrical component 104 and second electrical component 105 may be secured to opposite surfaces of support plate 103. For example, first electrical component 104 may be secured to surface 120, and second electrical component 105 may be secured to surface 121, or vice versa. Second electrical component 105 may be electrically connected to one or more components below roof 201 via wires extending from second electrical component 105, through IWTB 102, through ESPR 101, and through electrical junction box 107. Second electrical component 105 may be electrically connected to one or more components on top of roof 201 (e.g., if the second electrical component 105 is a GFCI outlet, then one or more components on the roof 201 may be plugged into such outlet).

FIG. 19 is an perspective view of a cross-section of an example support plate assembly where a housing of a first electrical component 104 is secured to surface 120 and a housing of a second electrical component 105 is secured to surface 121. FIG. 20 is a side view of a cross-section of the example support plate assembly of FIG. 19. In examples where the second electrical component 105 is secured to surface 121, the support plate 103 includes a through hole positioned behind the IWTB 102. The through hole, in examples, aligns with (e.g., at least partially overlaps with) the third aperture 136-b of the IWTB 102, when the IWTB 102 is attached to the support plate 103. As such, a through way is created from the interior of the IWTB 102 to the housing of the second electrical component 105 mounted on the rear surface 121 of the support plate 103. In some examples, third aperture 136-b of IWTB 102 may be threaded, and a housing for second electrical component 105 may also include a threaded opening that matches the threads of the third aperture 136-b. As such, IWTB 102 may be connected to second electrical component 105 (through the through hole in support plate 103) via a threaded chase nipple or short threaded pipe 147 (e.g., FIGS. 19 and 20). Welding or bonding may alternatively be used to couple second electrical component 105 and IWTB 102. In examples, the housing for the second electrical component 105 may include a GFCI box that includes a threaded aperture 148 in its back wall. In some examples, silicone may be added on the threads of the threaded chase nipple or short threaded pipe 147, third aperture 136-b, and/or housing of the second electrical component 105 to improve the seal. In addition, a back wall of the housing for the second electrical component 105 may further include threaded holes to receive fasteners (e.g., screws) 165 that connect the second electrical component to the support plate 103.

In some other examples, second electrical component 105 may be attached directly to ESPR 101, as illustrated in FIG. 16 (e.g., when ESPR 101 is square or rectangular shaped, or includes at least one flat surface in which second electrical component 105 may be directly attached to ESPR 101 on the flat surface). For example, second electrical component 105 may be attached to ESPR 101 below IWTB 102, below support plate 103, and above roof 201, electrical junction box 107, and upper flange 108. In some examples, second electrical component 105 may be attached directly to ESPR 101 as illustrated in FIG. 16 even when ESPR 101 comprises a cylindrical tube or other shape with a curved exterior surface. For example, where the second electrical component 105 comprises a GFCI outlet that includes a housing box, a back wall of that box may be curved to match a curve of the ESPR 101. Alternatively, a mounting plate may be provided that includes a first surface that is curved to match the curve of the exterior wall of the ESPR 101 and an opposite surface that is flat and onto which the second electrical component 105 may be mounted. As described with respect to the support plate 103, such mounting plate may also include a through-hole to allow the second electrical component to be connected (e.g., via a threaded chase nipple or short threaded pipe) to the ESPR 101.

In some examples, ESPR 101 may include a side aperture located behind second electrical component 105 for wires or electrical connections to be routed into or out of second electrical component 105 to/from ESPR 101. Such side aperture may be threaded. In some examples, when ESPR 101 includes at least one flat surface, support plate 103 may be able to be directly attached to ESPR 101 via the flat surface of ESPR 101. In some examples, the second electrical component 105 may be connected to the ESPR 101 via a threaded chase nipple or short threaded pipe similar to the arrangement described above with respect to examples where the second electrical component 105 is connected to the IWTB 102.

In examples where the first electrical component 104 and second electrical component 105 are configured to be attached to the support plate 103, both of the first electrical component 104 and the second electrical component 105 may be pre-attached to the support plate 103 and pre-wired with power wires that extend from electrical components 104, 105, separately through the respective second and third apertures 136-a and 136-b of IWTB 102 and (together) through first aperture 135. During installation, and after the ESPR 101 has been secured to roof 201 (as described herein), an installer may then route necessary wires from the required power sources (e.g., main service panel(s)) to electrical junction box 107. The installer may then thread the wires from the electrical components 104, 105 through the IWTB 102 and through the upper end of ESPR 101 to the electrical junction box 107. In examples, the pre-wired power wires from the electrical components 104, 105 are long enough to extend more than the length of ESPR 101 when the ESPR 101 is attached to IWTB 102. The installer may then attach the whole assembly (IWTB 102, support plate 103, first electrical component 104, and second electrical component 105) to the ESPR 101 (e.g., by rotating the assembly to thread the IWTB 102 onto the ESPR 101, or by other attachment methods). The wires from the electrical components 104, 105 may then be connected at junction box 107 to the wires from the required power sources (e.g., main service panel(s)), via wire nuts or other connectors.

Referring to FIGS. 2, 3, and 5-8, EPSSB 106 is a bracket designed to secure ESPR 101 to struts 112, which struts 112 may be secured to a portion of roof 201 (such as to angle irons/trusses 204 of roof 201). Although struts 112 are pictured defining a channel having a substantially U-shaped cross-section, other types of support elements are possible and contemplated; and the term “strut,” as used herein, is intended to refer to struts having different cross-sections and any such generally linear support pieces that can be used to secure the EPSSB 106 to the roof 201, such as angle brackets, L-brackets, etc. EPSSB 106 may exert a frictional force on ESPR 101 (e.g., using one or more fasteners, such as set screws, to axially exert force on outer surface 113 (FIG. 2) of ESPR 101). In examples, the EPSSB 106 is slidingly adjustable along the ESPR 101 to accommodate roofs of different thicknesses. EPSSB 106 may be secured to struts 112 via one or more additional fasteners, such as screws, bolts and nuts, etc. EPSSB 106 includes aperture 126 through which ESPR 101 fits. Aperture 126 may have a diameter equal to or greater than an outside diameter of ESPR 101. Aperture 126 may be a through hole (e.g., a cylindrical aperture) that extends completely through EPSSB 106. EPSSB 106 may include flanges 127 that extend substantially radially outwards from aperture 126. Flanges 127 are configured to rest atop of and/or attach to a top surface(s) of struts 112. For example, flanges 127 may include through fastener apertures 134 configured to receive fasteners (e.g., screws, bolts, etc.), which secure flanges 127 to struts 112 (with or without nuts that are tightened to the opposing side of such struts 112). In some examples, EPSSB 106 includes one or more adjustment apertures 128. Adjustment apertures 128 may be disposed in bracket portion 132 and extend radially with respect to aperture 126 within bracket portion 132. Adjustment apertures 128 may be threaded and configured to receive set screws. Fasteners (e.g., set screws) may be inserted into adjustment apertures 128 to frictionally contact ESPR 101 and secure EPSSB 106 in place with respect to ESPR 101. Fastener apertures 134 may be disposed in flanges 127 and/or body portion 131 to secure EPSSB 106 to struts 112. In some examples, the fastener apertures 134 may be threaded. In some examples, thickness 138 of flanges 127 is less than thickness 130 of body portion 131. That is, flanges 127 may be thinner than body portion 131, so that fastener apertures 134 can be formed in the flanges 127 and in a vertical wall of body portion 131. In examples, bracket portion 132 may extend downwards from body portion 131 (farther away from flanges 127). In examples, struts 112 (which may be unistruts), may include apertures on both the top and sides of such struts that may be aligned with fastener apertures 134 to (via fasteners) secure the struts to both the flanges 127 and the body portion 131. Braces 144 may provide additional structural support to bracket portion 132. When installed, EPSSB 106 may be configured with surfaces 133 of flanges 127 in contact with struts 112, and bracket portion 132 oriented facing downwards as illustrated, e.g., in FIGS. 2 and 8. In the example illustrated, a longitudinal axis of the aperture 126 is substantially orthogonal to the surfaces 133 of flanges 127; however, other arrangements are possible and contemplated. For example, if struts 112 are to be connected to surfaces of roof elements (e.g., angle irons/trusses 204, girders 155, etc.) that are not in the same plane with each other, then the longitudinal axis of the aperture 126 can be angled relative to the surfaces 133 of flanges 127 such that the ESPR 101 can still extend substantially vertically relative to the ground, for example. In some examples, EPSSB 106 may provide structural support against seismic or wind events by creating a secure attachment of ESPR 101 to roof 201. In examples, the structural support provided by EPSSB 106 and/or flange 108 is enough to eliminate the need for further above-roof structural support (such as wires, buttressing, etc.).

FIG. 9 illustrates an alternative embodiment EPSSB 139. EPSSB 139 may include similar flanges 127 that are formed on a single plate 140. However, EPSSB 139 may include two members 141 extending downwards and substantially orthogonal to the single plate 140. EPSSB 139 may similarly include apertures 128 and 134 and similarly connect to struts 112. Struts 112 may extend substantially orthogonally to longitudinal axis A of ESPR 101. In some examples, EPSSB 106 may be slidingly adjustable along ESPR 101 to a height below upper flange 108 to accommodate roofs of different thicknesses.

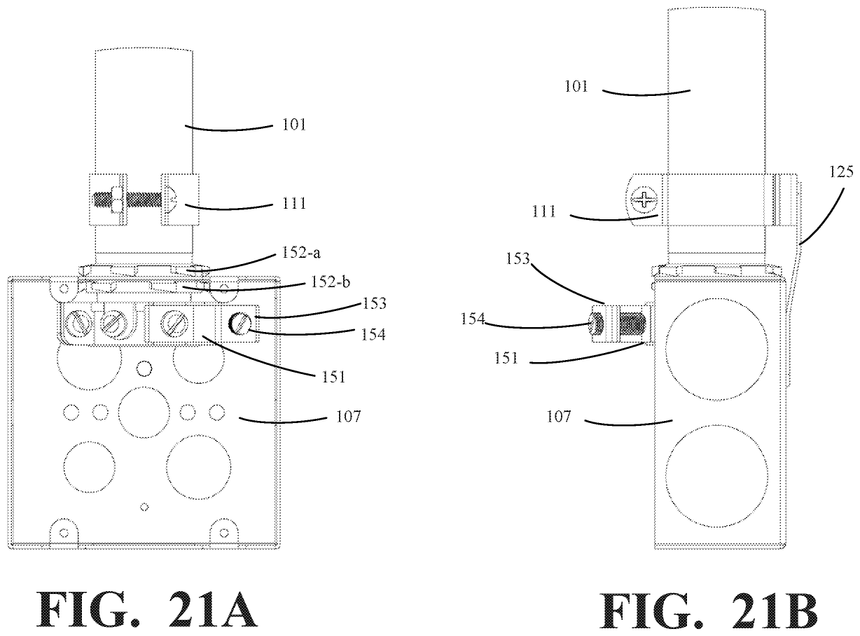

Electrical junction box 107 (FIG. 1, FIGS. 21A and 21B) is an enclosure housing electrical connections (e.g., wires and wiring connections). In examples, electrical junction box 107 is a single gang box or double gang box. Electrical junction box 107 may be made of substantially any material including metals, plastics, and/or ceramics, among other materials. Electrical junction box may be removably attached to ESPR 101 (e.g., via bottom outside threading 122 of ESPR 101 coupling to inside threading 123 (FIG. 2) of electrical junction box 107, via welding, adhesive-based attachment, using one or more fasteners, or any other attachment mechanism) at a bottom portion 137 (FIG. 9) of ESPR 101. Electrical junction box 107 is configured to receive electrical wiring from ESPR 101 and connect electrical wiring to other electrical components (e.g., below roof 201) (e.g., main service panel(s)). The bottom portion 137 of ESPR 101 refers to any components or portion of ESPR 101 included in pedestal assembly 801 (FIG. 8) and below (and inclusive of) upper flange 108 (e.g., including bottom outside threading 122 (FIG. 2)). The top portion of ESPR 101 refers to any portion of ESPR 101 above upper flange 108 (e.g., top outside threading 115 (FIG. 9)).

Upper flange 108 may comprise a rigid plate that is attached (e.g., welded) to ESPR 101. In examples, when the electrical pedestal assembly 100 is installed, upper flange 108 provides structural support in cooperation with EPSSB 106 and struts 112, to prevent tipping of electrical pedestal assembly 100. In some examples, upper flange 108 is disposed on top of some or all layers of roof 201, when installed. For example, upper flange 108 may be disposed, after installation, above a corrugated roof 202 of roof 201 and below roof insulation 203. In some other examples, upper flange 108 may be disposed, after installation, above both corrugated roof 202 of roof 201 and above roof insulation 203. Upper flange 108 extends outwards from ESPR 101 (e.g., radially outwards from the longitudinal axis of ESPR 101). Upper flange 108 may comprise a substantially flat sheet of material (e.g., rigid metal) that is welded or otherwise attached to ESPR 101. In examples, the upper flange 108 is attached to the ESPR 101 in a manner that creates a water-tight seal between the upper flange 108 and the ESPR 101, such as by welding, however, other attachment mechanisms are possible and contemplated. For example, the flange 108 may be slidingly adjustable along (e.g., removably attached to) the ESPR (e.g., using set screws) to allow adjustment of the position of the flange 108 on ESPR 101. For example, in some instances, the EPSSB 106 may be fixedly attached (e.g., welded) to the ESPR 101, while the upper flange 108 may be slidingly adjustable along the ESPR 101 to accommodate roofs of different widths. In other examples, both of the EPSSB 106 and the upper flange 108 may be slidingly adjustable along the ESPR 101. If the position of the upper flange 108 along the ESPR 101 is adjustable, a seal between ESPR 101 and flange 108 may be waterproofed by other mechanisms (e.g., via sealing boot, a sheath, etc.). Upper flange 108 may be disposed between EPSSB 106 and IWTB 102 at a height that permits the support plate 103 to be at a desired height for electrical components 104, 105 and leaves enough room for EPSSB 106 to be disposed below the roof 201 and above junction box 107. Upper flange 108 may be substantially square shaped, although other shapes are possible and contemplated.

Conduit 109 may comprise a durable, flexible tube that protects and routes electrical wiring and cables. In other examples, conduit 109 may be rigid. Conduit 109 extends downwards from first electrical component 104 and carries wiring that electrically connects first electrical component 104 with a rooftop electrical component serviced by the first electrical component 104. For example, when the first electrical component 104 is an electrical disconnect, then conduit 109 may include wiring to an electrical component on the roof 201 requiring such disconnect (e.g., air conditioning unit, etc.).

First collar 110 is a support component designed to clamp onto conduit 109 and hold conduit 109 in place. First collar 110 is attached to support plate 103 (e.g., on surface 120). First collar 110 may include threaded holes and a screw to adjustably tighten first collar 110 around conduit 109. First collar 110 may be substantially adjacent or proximal to a bottom edge 124 of support plate 103.

Referring to FIGS. 21A and 21B, second collar 111 (e.g., a support clamp) is a collar designed to clamp onto ESPR 101 and structurally connect ESPR 101 to electrical junction box 107 via a support bracket 125 attached to second collar 111 and to electrical junction box 107. Second collar 111 may include a screw to adjustably tighten second collar 111 around ESPR 101. In some examples, both second collar 111 and support bracket 125 are made from an electrically conductive material, such as a metal. In other examples, they can be made from any suitable material.

Because ESPR 101 functions as both a support pole and a raceway, ESPR 101 should be grounded. In some examples, support bracket 125 may comprise an electrically conductive strip of material that provides a grounding connection from ESPR 101 (and second collar 111) to electrical junction box 107 (which is in turn separately grounded, such as by connection to a ground wire connected to the main service panel of the building). In addition to, or instead of, grounding the ESPR 101 via second collar 111 and support bracket 125, a grounding bushing 151 may be provided. In examples, grounding bushing 151 is attached to a portion of the ESPR that extends into electrical junction box 107. Grounding bushing 151 may be secured to the ESPR 101 via set screws and also include a lug 153 and grounding screw 154 into which a ground wire can be clamped/connected (e.g., to the building's main service panel). As such, the grounding bushing 151 may be used to ground ESPR 101 (and any electrical components grounded thereto). Grounding bushing 151 may be attached to ESPR 101 substantially within electrical junction box 107 as illustrated in FIGS. 21A and 21B. In some examples, ESPR 101 may also (or alternatively) be mechanically attached to electrical junction box 107 via one or more top and bottom lock rings 152-a and 152-b, disposed above and inside electrical junction box 107 respectively, as illustrated in FIG. 21A.

Struts 112 are structural components that resists compression and are made of a rigid material (e.g., steel). EPSSB 106 may attach to struts 112 via one or more fasteners to structurally secure electrical pedestal assembly 100. As discussed, in some examples, struts 112 may comprise L-brackets.

Referring to FIG. 8, electrical pedestal assembly 100 may include pedestal assembly 801 and support plate assembly 802. Pedestal assembly 801 may include ESPR 101, upper flange 108, EPSSB 106, second collar 111, electrical junction box 107, or any combination of these. Support plate assembly 802 may include IWTB 102, support plate 103, first electrical component 104, second electrical component 105, conduit 109, first collar 110, or a combination of these. During installation, and in examples, pedestal assembly 801 and support plate assembly 802 may be able to be installed separately from one another, which can be advantageous. For example, pedestal assembly 801 may be installed independently of the need for any electrical work (e.g., during a “rough-in” stage of building). Because the pedestal assembly 801 exposes only a rigid ESPR 101 and (in some examples, upper flange 108) above the roof 201, the electrical components 104, 105 need not be exposed to damage while the roof 201 (and/or other portions of the building) are still being constructed. Rather, a roofer or other non-electrician building personnel, can install the pedestal assembly 801. The pedestal assembly 801 can then be secured to the roof 201, and the hole in the roof 201 to accommodate the pedestal assembly can be sealed (using a sealing boot and/or other methodologies practiced by roofing professionals). Once an electrician is ready to connect the electrical components 104, 105, the support plate assembly 802 may be installed onto the already-installed pedestal assembly 801. Inside threading 116 of IWTB 102 may be coupled to top outside threading 115 of ESPR 101, with wiring from first electrical component 104, second electrical component 105, or both, able to be fed down through ESPR 101, as previously described. In examples, this eliminates the need for an electrician and a roofer to coordinate work schedules, as the electrician can install the support plate assembly 802 after the roofer has completed the roof and installed and waterproofed the pedestal assembly. In addition, pedestal assembly 801 and support plate assembly 802 may be able to be shipped separately or as two separate sections of a shipment.

In use, wiring electrically connects a service panel (e.g., below roof 201) with first electrical component 104 and/or second electrical component 105, which in turn are connected to various electrical equipment, for example, disposed on roof 201. When, for example, first electrical component 104 is an electrical disconnect, power is provided from the service panel to electrical equipment on roof 201, with the electrical disconnect selectively interrupting the power provided. Wiring may extend from the service panel to electrical junction box 107, where it may be connected to wiring that extends through ESPR 101, through IWTB 102 via first aperture 135, and to first electrical component 104 via second aperture 136-a. Wiring continues from first electrical component 104 to the electrical equipment on roof 201 via conduit 109. The electrical disconnect may be switched on or off to selectively interrupt power provided from the service panel to the electrical equipment on roof 201.

When, in examples, second electrical component 105 is a GFCI outlet, power is provided from the service panel to electrical equipment on roof 201, with the GFCI interrupting the power provided when a ground fault is detected. Wiring may extend from the service panel to electrical junction box 107, where it may be connected to wiring that extends through ESPR 101, through IWTB 102 via first aperture 135, and to second electrical component 105 via third aperture 136-b. Electrical equipment on roof 201 may be plugged into the GFCI outlet. The GFCI may interrupt power provided from the service panel to the electrical equipment on roof 201 when a ground fault is detected.

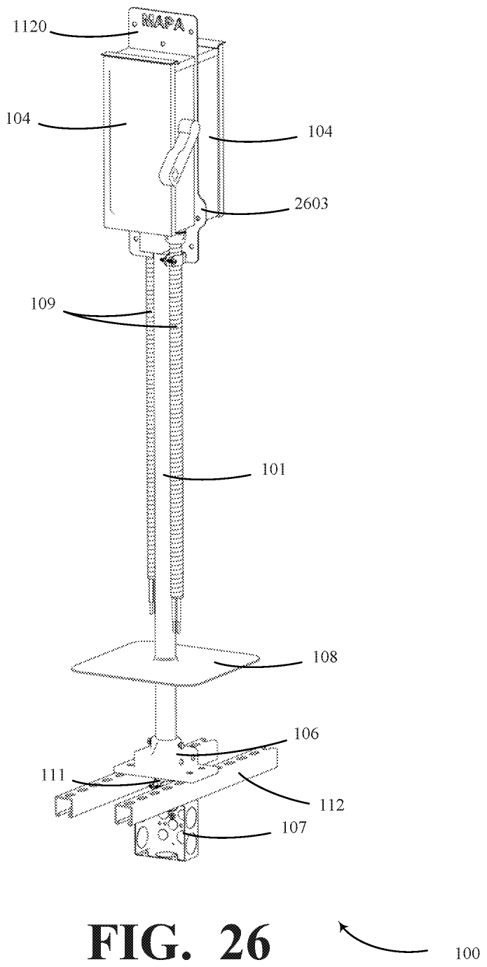

In some examples, and referring concurrently to FIGS. 26-31B, the electrical pedestal assembly 100 may include two instances of the first electrical component 104 (e.g., two electrical disconnect components) mounted on opposite sides of a modified support plate 2603. In such examples, the second electrical component 105 (e.g., a GFCI outlet) may be omitted and replaced with a second electrical disconnect component 104, such that the support plate 2603 supports a first electrical disconnect component 104 on a first surface 1120 and supports a second electrical disconnect component 104 on a second surface 1121 opposite the first surface 1120. This configuration may enable selective interruption of power for more than one rooftop electrical load (e.g., two separate HVAC units) while still using a single ESPR 101 as a structural support pole and wiring raceway through the roof. In some examples, support plate 2603 may include any one or more features of support plate 103, but may be modified from support plate 103 to support a second electrical disconnect component 104.

FIG. 26 illustrates an example of this dual-disconnect configuration. As shown, the support plate 2603 is supported by the ESPR 101, and the two electrical disconnect components 104 are disposed on opposite sides of the support plate 2603. In the illustrated example, each electrical disconnect component 104 has a corresponding conduit 109 extending from the electrical disconnect component 104 for routing wiring toward a corresponding rooftop electrical component serviced by that disconnect. FIG. 26 further illustrates that, aside from the duplication of the first electrical component 104 and its associated conduit 109 on the opposite side of the support plate 2603, the remaining pedestal structure may be similar as in other examples described herein, including the upper flange 108, the EPSSB 106, the second collar 111, the struts 112, and the electrical junction box 107.

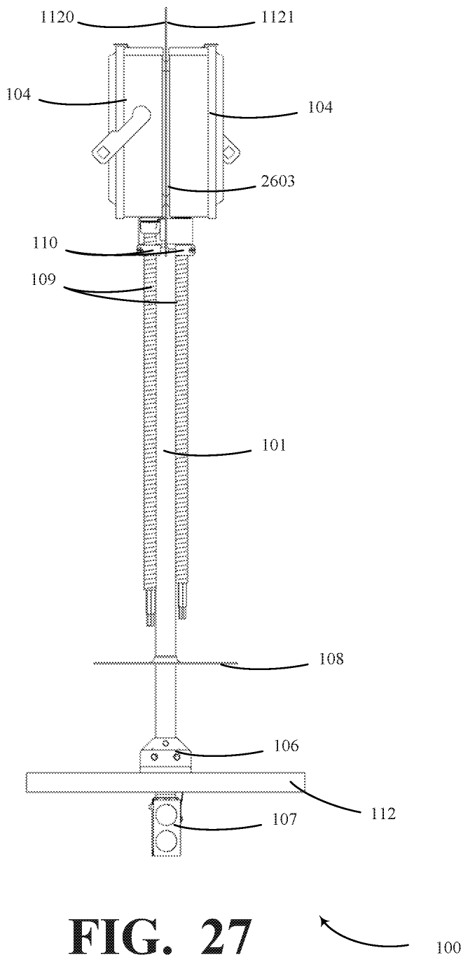

FIG. 27 illustrates a side view of the example electrical pedestal assembly of FIG. 26. In addition to showing the two electrical disconnect components 104 mounted on opposite sides of the support plate 2603 and the corresponding conduits 109, FIG. 27 further illustrates a first collar 110 associated with at least one of the conduits 109. As described elsewhere herein, the first collar 110 may be attached to the support plate 2603 and may be configured to clamp onto the conduit 109 to hold the conduit 109 in place, such that movement of the conduit 109 relative to the support plate 2603 is reduced during installation and/or use. In some examples, the dual-disconnect configuration includes a respective first collar 110 for each conduit 109, such that each conduit 109 is supported at the support plate 2603 on its corresponding side of the support plate 2603.

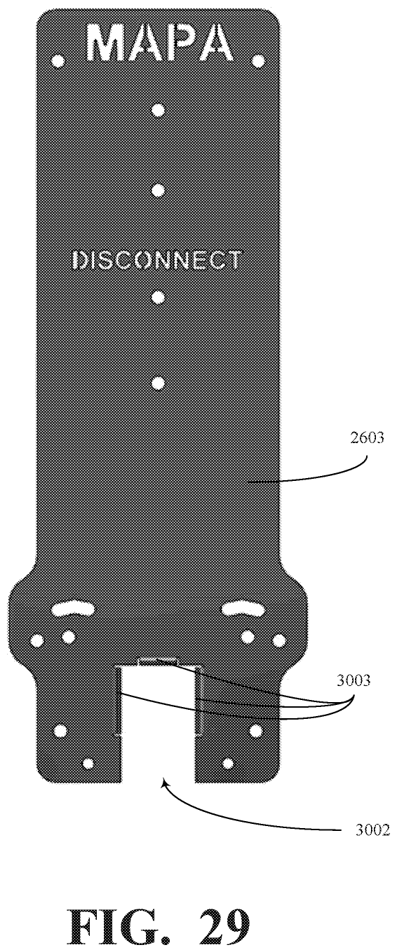

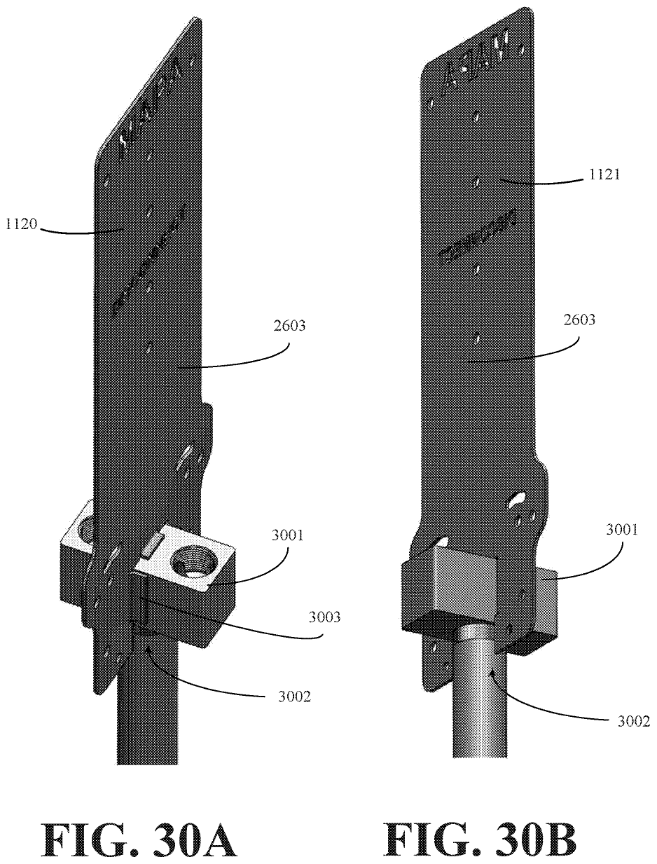

In some examples of the dual-disconnect configuration, components associated with the first electrical component 104 may be duplicated on the opposite side of the support plate 2603. For example, and referring concurrently to FIGS. 26-28, the assembly may include two conduits 109, one corresponding to each electrical disconnect component 104. In such examples, the support plate 2603 may be coupled to the ESPR 101 by a double-sided mounting block 3001 positioned at a lower portion of the support plate 2603. The double-sided mounting block 3001 may be received at least partially within a lower cutout 3002 (see FIG. 29) of the support plate 2603 and may be attached to tabs 3003 (see FIGS. 30A and 30B) of the support plate 2603. The double-sided mounting block 3001 may include a lower aperture 3005 configured to receive the ESPR 101, such that the ESPR 101 supports the support plate 2603 through the double-sided mounting block 3001. Thus, the dual-disconnect configuration may provide a central mounting structure for supporting the support plate 2603 on the ESPR 101 while allowing the electrical disconnect components 104 to be mounted on opposite sides of the support plate 2603.

In some examples, the double-sided mounting block 3001 is configured to provide a wiring transition between the ESPR 101 and the corresponding first electrical component 104. For example, wiring routed upward through the ESPR 101 may pass into the double-sided mounting block 3001 through lower aperture 3005 and may then be directed from the double-sided mounting block 3001 toward one or both first electrical components 104 mounted on opposite sides of the support plate 2603 through one or both of upper apertures 3004. In this manner, the double-sided mounting block 3001 may provide both a mechanical mounting interface between the ESPR 101 and the support plate 2603 and a wiring transition structure for routing electrical wiring from the ESPR 101 to the first electrical components 104. Accordingly, upper apertures 3004 and lower aperture 3005 may be in communication such that wiring may be able to pass from lower aperture 3005, through mounting block 3001 which may be at least partially hollow, and out of mounting block 3001 through upper aperture 3004.

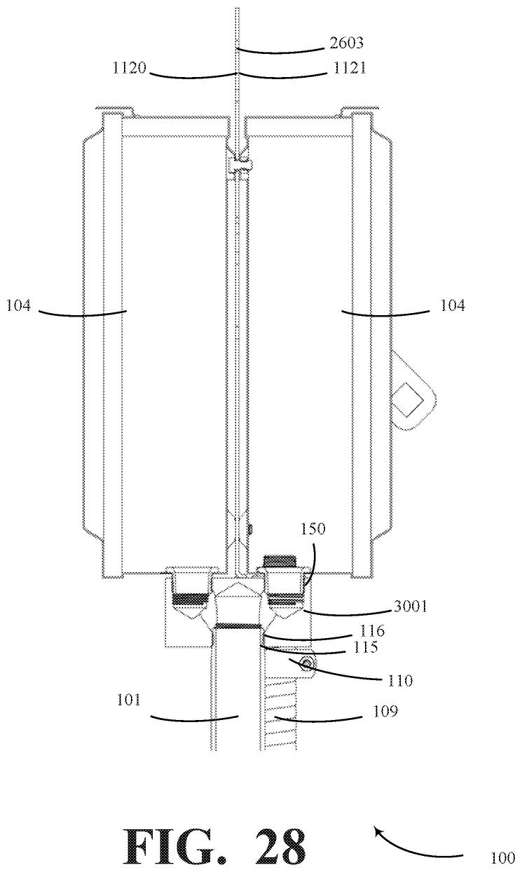

FIG. 28 illustrates a sectional side view of an upper portion of the electrical pedestal assembly of FIG. 26, and shows the relationship between the support plate 2603, the two electrical disconnect components 104, and the mounting structure associated with the electrical disconnect components 104. In the illustrated example, FIG. 28 shows the support plate 2603 with the two electrical disconnect components 104 disposed on opposite sides thereof, as well as one of the corresponding conduits 109 and the corresponding first collar 110. FIG. 28 also illustrates the double-sided mounting block 3001 positioned at the lower portion of the support plate 2603 and coupled to the ESPR 101. In some examples, the double-sided mounting block 3001 may include upper apertures 3004 associated with mounting or supporting structure for the electrical disconnect components 104 and a lower aperture 3005 configured to receive the ESPR 101. In some examples, the lower aperture 3005 may be threaded such that the ESPR 101 is threadingly engaged with the double-sided mounting block 3001.

In use, and consistent with the routing approaches described elsewhere herein, wiring may extend from a power source below the roof into the electrical junction box 107 and then through the ESPR 101 toward the top portion of the electrical pedestal assembly. In the dual-disconnect configuration, the ESPR 101 may support the support plate 2603 through the double-sided mounting block 3001 while the electrical disconnect components 104 are mounted on opposite sides of the support plate 2603. Wiring may then be routed from each electrical disconnect component 104 toward a corresponding rooftop electrical load via its corresponding conduit 109. Accordingly, the dual-disconnect configuration may provide a single roof penetration through which wiring may be brought to the rooftop while providing two separate electrical disconnect components 104 supported by the support plate 2603 and the ESPR 101.

In some examples, and referring concurrently to FIGS. 26-31B, the electrical pedestal assembly 100 may include a support plate arrangement configured for a dual-sided mounting configuration in which the ESPR 101 is received generally in line longitudinally with the support plate 2603. In such examples, the support plate 2603 may support respective first electrical components 104 on opposite sides thereof, while a mounting structure positioned at a lower portion of the support plate 2603 mechanically couples the support plate 2603 to the ESPR 101. This arrangement may provide a compact and robust mounting interface that positions the ESPR 101 centrally relative to the support plate 2603 while allowing electrical components to be mounted on opposite sides of the support plate 2603.

FIG. 29 illustrates a front view of an example support plate assembly for such a dual-sided configuration. In the illustrated example, the support plate 2603 includes a lower cutout 3002 formed at a bottom portion thereof. The lower cutout 3002 may be substantially centered with respect to the width of the support plate 2603 and may be sized to receive at least a portion of a double-sided mounting block 3001. In some examples, the support plate 2603 further includes a plurality of tabs 3003 disposed around the lower cutout 3002. The tabs 3003 may be bent relative to a main plane of the support plate 2603 and may be welded or otherwise attached to the double-sided mounting block 3001 to secure the double-sided mounting block 3001 to the support plate 2603.

In the example of FIGS. 26-31, the double-sided mounting block 3001 is received at least partially within the lower cutout 3002 of the support plate 2603, and the ESPR 101 is received by the double-sided mounting block 3001. In this manner, the double-sided mounting block 3001 may provide a mechanical interface between the support plate 2603 and the ESPR 101. The double-sided mounting block 3001 may define a lower aperture 3005 configured to receive an upper portion of the ESPR 101, such that the ESPR 101 supports the support plate 2603 through the double-sided mounting block 3001 (see FIGS. 30A and 30B). In some examples, the double-sided mounting block 3001 may be welded, bonded, or otherwise fixedly attached to the tabs 3003 of the support plate 2603.

FIG. 30A illustrates a top perspective view of the example assembly of FIG. 29, and FIG. 30B illustrates a bottom perspective view of the example assembly of FIG. 29. As shown in FIGS. 30A and 30B, the double-sided mounting block 3001 may project from the lower portion of the support plate 2603 and may be positioned such that the ESPR 101 extends into the double-sided mounting block 3001 from below.

In some examples, the double-sided mounting block 3001 may include structural components on opposite sides thereof for mounting or supporting portions of the first electrical components 104 and/or associated attachment structures. For example, the double-sided mounting block 3001 may include upper apertures 3004 at an upper portion thereof, and the upper apertures 3004 may include internal threading 3006. The upper apertures 3004 may receive fasteners or other mounting structures (e.g., a threaded chase nipple) associated with the electrical components mounted on opposite sides of the support plate 2603. In other examples, ESPR 101 may be configured to attach to mounting block 3001 in any number of other ways including adhesive-based attachment, welding, fasteners (e.g., screws), snap-in mechanisms, or any other attachment mechanism. Accordingly, the double-sided mounting block 3001 may not only provide the interface to the ESPR 101, but also contribute to the structural support of the components mounted to the support plate 2603.

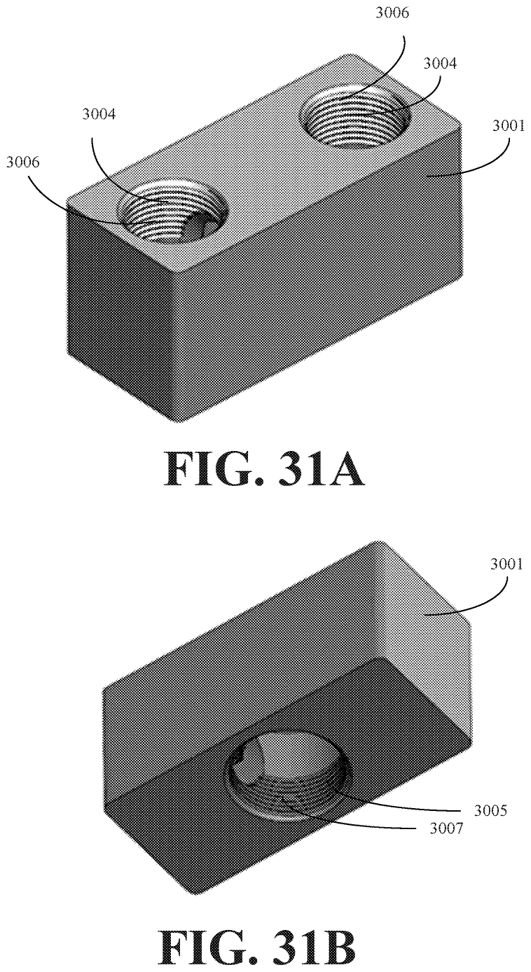

FIG. 31A illustrates a top perspective view of the double-sided mounting block 3001, and FIG. 31B illustrates a bottom perspective view of the double-sided mounting block 3001. As shown in FIG. 31A, the double-sided mounting block 3001 includes a pair of upper apertures 3004 at an upper portion thereof. In some examples, each of the upper apertures 3004 is threaded, such that each upper aperture 3004 includes internal threading 3006. The upper apertures 3004 may be configured to receive fasteners, mounting features, or other attachment structures associated with components disposed on opposite sides of the support plate 2603.

As shown in FIG. 31B, the double-sided mounting block 3001 may further include a lower aperture 3005 at a lower portion thereof configured to receive the ESPR 101. In some examples, the lower aperture 3005 includes internal threading 3007 such that the ESPR 101 may be threadingly engaged with the double-sided mounting block 3001. In other examples, the ESPR 101 may be secured within the lower aperture 3005 by another attachment arrangement, such as welding, bonding, an interference fit, or one or more fasteners. The threaded nature of the upper apertures 3004 and the lower aperture 3005 of the double-sided mounting block 3001 may facilitate assembly and may provide a secure mechanical connection among the support plate 2603, the double-sided mounting block 3001, and the ESPR 101.

In use, the support plate 2603 may be coupled to the ESPR 101 by securing the double-sided mounting block 3001 within the lower cutout 3002 of the support plate 2603 and attaching the tabs 3003 of the support plate 2603 to the double-sided mounting block 3001. The ESPR 101 may then be received into the lower aperture 3005 of the double-sided mounting block 3001. With the support plate 2603 thereby supported by the ESPR 101, first electrical components 104 may be mounted on opposite sides of the support plate 2603 to provide a dual-sided electrical pedestal configuration.

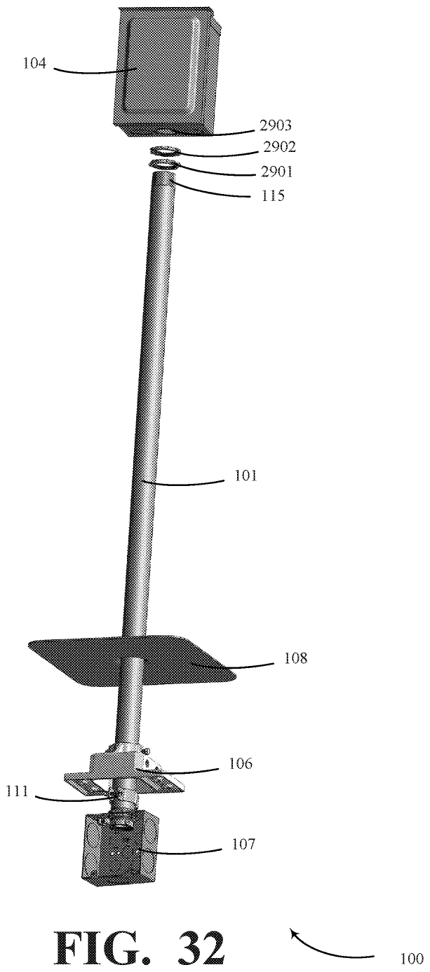

In some examples, and referring concurrently to FIGS. 32-34, the electrical pedestal assembly 100 may be configured such that the ESPR 101 is coupled directly to a housing of a first electrical component 104 (e.g., an electrical disconnect component), rather than being coupled to an integrated wiring transition box, mounting block, and/or support plate assembly. In such examples, the first electrical component 104 may be mounted directly to ESPR 101, such that electrical wiring routed through the ESPR 101 can transition into the first electrical component 104 without first passing through a separate transition enclosure.

In the direct-mount examples of FIGS. 32-34, the pedestal assembly may still include the bottom-side structures previously described herein for supporting and stabilizing the ESPR 101 relative to a roof, such as the electrical junction box 107 at a bottom portion of the ESPR 101, the second collar 111, the upper flange 108, the electrical pedestal stability support bracket (EPSSB) 106, and one or more struts 112 that secure the EPSSB 106 to an underside of the roof. Accordingly, the direct-mount examples may change the upper mounting arrangement for the first electrical component 104 while retaining the below-roof support and stabilization features described for other examples.

Referring concurrently to FIGS. 32-34, the direct-mount coupling between the ESPR 101 and the first electrical component 104 may be achieved using a pair of locking nuts 2901 and 2902 that engage a threaded portion 115 of the ESPR 101. In examples, the threaded portion 115 extends upward from a top portion of the ESPR 101 and through an opening in a bottom wall of the housing of the first electrical component 104. The first locking nut 2901 may be disposed on an underside of the first electrical component 104 and may be threaded onto the threaded portion 115 and advanced upward until the first locking nut 2901 is substantially flush with, and bears against, the underside of the bottom wall of the first electrical component 104.

In such examples, the second locking nut 2902 may be disposed inside the housing of the first electrical component 104 and may be threaded onto the same threaded portion 115 from an opposite side of the bottom wall of the first electrical component 104. The second locking nut 2902 may be advanced downward (or otherwise toward the bottom wall) until the second locking nut 2902 bears against an inner surface of the bottom wall of the first electrical component 104. Thus, when both locking nuts 2901 and 2902 are threaded onto the threaded portion 115 on opposite sides of the bottom wall, the two locking nuts 2901 and 2902 may clamp the bottom wall of the first electrical component 104 therebetween, thereby mechanically securing the first electrical component 104 to the ESPR 101 and resisting relative axial movement between the first electrical component 104 and the ESPR 101.

FIG. 32 illustrates a partially exploded view of an example assembly configured for the direct-mount interface described above. In the illustrated example, the bottom portion of the electrical pedestal assembly 100 includes the electrical junction box 107, the second collar 111, the EPSSB 106, and the upper flange 108, each positioned relative to the ESPR 101 as described in other examples herein. FIG. 32 further illustrates the ESPR 101 including the threaded portion 115 at its top portion, and illustrates the first locking nut 2901 and the second locking nut 2902 as separate components configured to threadably engage the threaded portion 115. FIG. 32 further illustrates the first electrical component 104 positioned to receive the threaded portion 115 through an opening 2903 in its bottom wall such that the locking nuts 2901 and 2902 can be installed on opposite sides of that bottom wall to secure the first electrical component 104 to the ESPR 101.

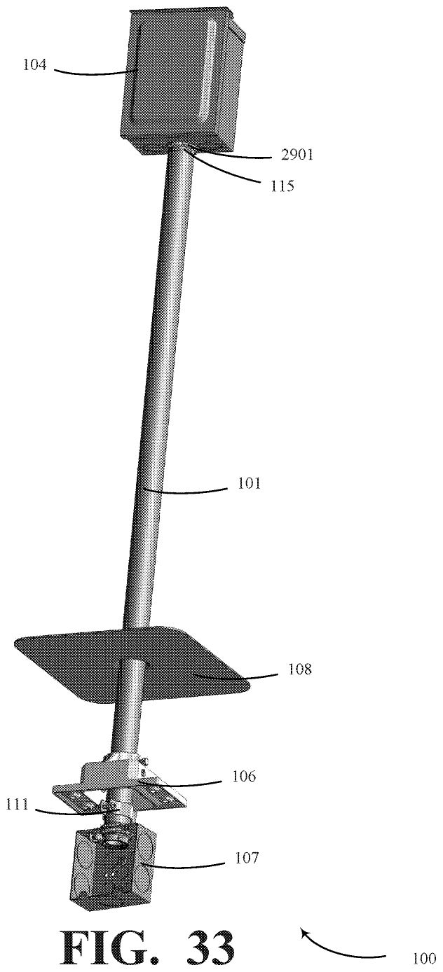

FIG. 33 illustrates an assembled view of the example electrical pedestal assembly of FIG. 32. In this assembled view, the first electrical component 104 is shown coupled to the top portion of the ESPR 101 via the locking-nut interface, and the first locking nut 2901 is visible on the underside of the first electrical component 104 where it engages the threaded portion 115 and bears against the bottom wall of the first electrical component 104. In the illustrated assembled configuration, the second locking nut 2902 is disposed inside the housing of the first electrical component 104 and therefore may not be visible in the exterior view of FIG. 33, while still cooperating with the first locking nut 2901 to clamp the bottom wall of the first electrical component 104 and secure the first electrical component 104 to the ESPR 101.

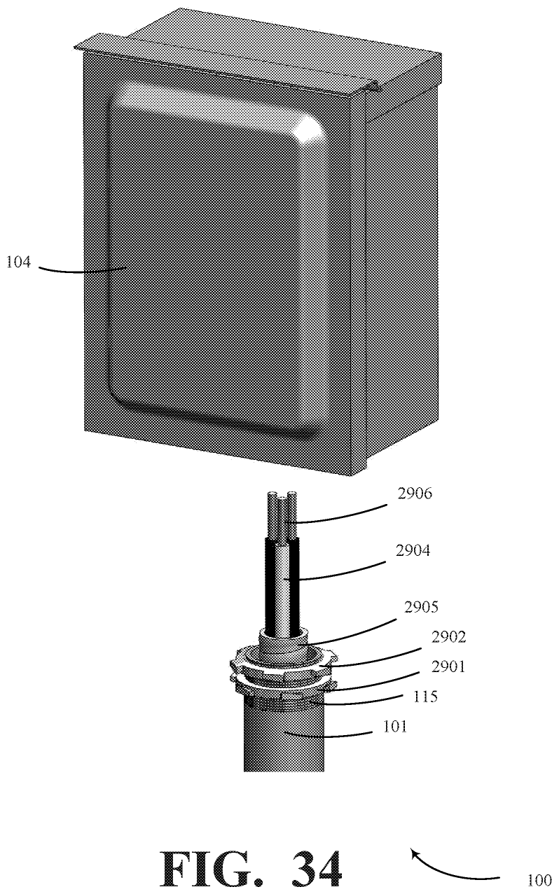

FIG. 34 illustrates an enlarged view of an upper portion of the electrical pedestal assembly 100 focusing on the direct-mount interface between the ESPR 101 and the first electrical component 104. In the illustrated example, FIG. 34 shows the top portion of the ESPR 101 including the threaded portion 115, and shows the first locking nut 2901 and the second locking nut 2902 both threaded onto the threaded portion 115. FIG. 34 further depicts the first electrical component 104 separated from the ESPR 101 and the locking nuts 2901 and 2902, to illustrate how the two locking nuts 2901 and 2902 are positioned to clamp the bottom wall when the first electrical component 104 is seated onto the threaded portion 115.

FIG. 34 further illustrates wiring routed through the ESPR 101 toward the first electrical component 104. In the illustrated example, one or more wires 2906 are disposed within respective wire sheaths 2904, and the wire sheaths 2904 are collectively disposed within a wire sleeve 2905. The wire sleeve 2905 extends from within the ESPR 101 and exits the top portion of the ESPR 101 so that the wire sleeve 2905 (and the wire sheaths 2904 and wires 2906 therein) can be routed into an interior of the first electrical component 104 when the first electrical component 104 is installed onto the threaded portion 115. Accordingly, the wire sleeve 2905 may provide a collective protective covering for the wire sheaths 2904 as the wiring transitions from the ESPR 101 into the first electrical component 104.

In use, wiring may be routed from a power source below the roof into the electrical junction box 107 and upward through the ESPR 101 toward the first electrical component 104. In the direct-mount examples of FIGS. 32-34, the wiring may transition from the ESPR 101 into the first electrical component 104 through the bottom wall opening of the first electrical component 104, for example within the wire sleeve 2905. The first electrical component 104 may then selectively interrupt power delivered through such wiring in the manner described for electrical disconnect components elsewhere herein.

Although specific devices or components have been recited throughout the disclosure as performing specific functions, one of skill in the art will appreciate that these devices or components are provided for illustrative purposes, and other devices or components may be employed to perform the functionality disclosed herein without departing from the scope of the disclosure. For example, unless otherwise specified, any threaded connection between components disclosed herein may be replaced by other forms of attachment, such as bonding, welding, etc.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurement techniques utilized herein. To the extent such terms may not be clearly defined or understood by one having skill in the art, the terms “about” or “substantially” shall mean plus or minus ten percent. Relative positioning terms like “top” “bottom” “side” or other such terms may be used with respect to the directions when viewing each drawing and/or may be used with respect to proximity to the ground. For example, “bottom” is more proximal to the ground than “top.” Unless stated otherwise, the depicted Figures may depict components oriented with the bottom of the Figure oriented towards the ground.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. An electrical pedestal assembly for a roof, comprising:
an electrical support pole raceway (ESPR) comprising a hollow, rigid shell;
a support plate having a first surface and an opposite, second surface;
a first electrical component comprising an electrical disconnect component; and
a second electrical component comprising an electrical disconnect component,
wherein the first electrical component is mounted on the first surface of the support plate, and wherein the second electrical component is mounted on the second surface of the support plate.

2. The electrical pedestal assembly of claim 1, further comprising a first conduit corresponding to the first electrical component and a second conduit corresponding to the second electrical component.

3. The electrical pedestal assembly of claim 2, further comprising a first collar attached to the support plate and configured to clamp onto at least one of the first conduit or the second conduit.

4. The electrical pedestal assembly of claim 3, wherein the electrical pedestal assembly includes a respective first collar for each of the first conduit and the second conduit.

5. The electrical pedestal assembly of claim 1, further comprising a mounting block, wherein the support plate is mounted to the mounting block, and the mounting block is mounted to the ESPR.

6. The electrical pedestal assembly of claim 5, wherein the mounting block is further configured to provide a wiring transition between the ESPR and both of the first electrical component and the second electrical component.

7. The electrical pedestal assembly of claim 1, further comprising:
an electrical junction box attached to a bottom portion of the ESPR; and
a collar attached to the bottom portion of the ESPR and proximal to the electrical junction box, wherein the collar is attached to the electrical junction box via a support bracket.

8. An electrical pedestal assembly for a roof, comprising:
an electrical support pole raceway (ESPR), comprising a hollow shell having a top portion including a top opening and a bottom portion including a bottom opening;
a first electrical component comprising an electrical disconnect component;
a threaded portion of the ESPR extending upward from the top portion of the ESPR and through an opening in a bottom wall of a housing of the first electrical component; and
a pair of locking nuts engaged with the threaded portion,
wherein the pair of locking nuts clamp the bottom wall therebetween, thereby mechanically securing the first electrical component to the ESPR.

9. The electrical pedestal assembly of claim 8, wherein a first locking nut of the pair of locking nuts is configured to be disposed on an underside of the first electrical component and is configured to be advanced upward until the first locking nut bears against the underside of the bottom wall.

10. The electrical pedestal assembly of claim 8, wherein a second locking nut of the pair of locking nuts is configured to be disposed inside the housing of the first electrical component and is configured to be advanced until the second locking nut bears against an inner surface of the bottom wall.

11. The electrical pedestal assembly of claim 8, further comprising an electrical junction box attached to a bottom portion of the ESPR.

12. The electrical pedestal assembly of claim 8, further comprising:
an upper flange attached to the ESPR; and
an electrical pedestal stability support bracket (EPSSB) removably attached to a bottom portion of the ESPR and below the upper flange, wherein the EPSSB is further configured to attach to a plurality of struts for attachment of the EPSSB to an underside of a roof.

13. The electrical pedestal assembly of claim 8, wherein an outside surface of the ESPR is curved.

14. An electrical pedestal assembly for a roof, comprising:
an electrical support pole raceway (ESPR) comprising a hollow, rigid shell;
a first electrical component comprising an electrical disconnect component, wherein the ESPR is coupled directly to a housing of the first electrical component;
an electrical junction box attached to a bottom portion of the ESPR; and
an electrical pedestal stability support bracket (EPSSB) removably attached to the bottom portion of the ESPR, wherein the EPSSB is further configured to attach to a plurality of struts for attachment of the EPSSB to an underside of a roof.

15. The electrical pedestal assembly of claim 14, further comprising an upper flange attached to the ESPR.

16. The electrical pedestal assembly of claim 14, further comprising a collar attached to the bottom portion of the ESPR and proximal to the electrical junction box, wherein the collar is attached to the electrical junction box via a support bracket.

17. The electrical pedestal assembly of claim 14, further comprising a threaded portion of the ESPR extending upward through an opening in a bottom wall of the housing of the first electrical component.

18. The electrical pedestal assembly of claim 17, further comprising a pair of locking nuts engaged with the threaded portion.

19. The electrical pedestal assembly of claim 18, wherein the pair of locking nuts clamps the bottom wall therebetween, thereby mechanically securing the first electrical component to the ESPR.

20. The electrical pedestal assembly of claim 14, further comprising a grounding bushing attached to the bottom portion of the ESPR, wherein the grounding bushing is configured to electrically connect the ESPR to a ground wire.
